(19) United States
(12) Patent Application Publication
(10) Pub. No.: US 2016/0286425 A1
(43) Pub. Date: Sep. 29, 2016

(54) METHOD AND SYSTEM FOR WIRELESS NETWORK OPTIMIZATION

(71) Applicant: Nokia Solutions and Networks OY, Espoo (FI)

(72) Inventors: Eamonn GORMLEY, Bothell, WA (US); David James RYAN, Bothell, WA (US); Derek Stephen HILBORN, Bothell, WA (US); Jeffrey Paul HARRANG, Bothell, WA (US); Adrian YIP, Bothell, WA (US)

(21) Appl. No.: 15/078,927

(22) Filed: Mar. 23, 2016

Related U.S. Application Data
(60) Provisional application No. 62/136,947, filed on Mar. 23, 2015.
(60) Provisional application No. 62/137,025, filed on Mar. 23, 2015.
(60) Provisional application No. 62/136,994, filed on Mar. 23, 2015.
(60) Provisional application No. 62/137,031, filed on Mar. 23, 2015.
(60) Provisional application No. 62/136,894, filed on Mar. 23, 2015.
(60) Provisional application No. 62/136,967, filed on Mar. 23, 2015.

(51) Int. Cl. H04W 28/02; H04W 16/18

(52) U.S. Cl. CPC H04W 28/021; H04W 16/18; H04W 84/18

(57) ABSTRACT

Wireless network performance may be improved by combined phase and power coordinated scheduling, usage-aware interference mitigation scheduling, estimating interference in a power scheduled network, coordinating transmission power levels using thresholds, and locally generated pseudorandom power schedules.

### CROSS-REFERENCES TO RELATED APPLICATIONS

The present disclosure claims priority to U.S. Provisional Application No. 62/136,994 filed Mar. 23, 2015, (Attorney docket No. A223AA-004310PV), 62/137,025 filed Mar. 23, 2015, (Attorney docket No. A223AA-004610PV), 62/137,031 filed Mar. 23, 2015, (Attorney docket No. A223AA-004710PV), 62/136,947 filed Mar. 23, 2015 (Attorney docket No. A223AA-004910PV), 62/136,894 filed Mar. 23, 2015 (Attorney docket No. A223AA-005110PV), 62/136,967 filed Mar. 23, 2015 (Attorney docket No. A223AA-005710PV), each of which is incorporated by reference herein for all purposes.

### BACKGROUND

In order to serve the increased demand, wireless communication networks are becoming more diverse and complex, and subsequently are becoming more difficult to manage. A Self-Organizing Network (SON) simplifies and automates multiple processes to efficiently manage diverse communication networks.

Many SON algorithms require information about the coverage areas of cells in order to make better optimization decisions. However, it can be difficult to obtain cell coverage information for a network. Cell coverage information could be retrieved from the output of a network planning tool, but this information is not always available to a SON tool. In addition, network planning tools tend to use large amounts of data to determine cell coverage, so planning tools tend to be relatively slow and inefficient.

### BRIEF SUMMARY

Embodiments of this disclosure provide a method and a system for automatically adapting the parameters of a wireless network.

### BRIEF DESCRIPTION OF THE DRAWINGS

FIG. 1 illustrates a wireless communications system according to an embodiment.

FIG. 2 illustrates a network resource controller according to an embodiment

FIG. 3 shows a process 300 for automatically determining a target CINR threshold.

FIG. 4 shows CINRs of CPE.

FIG. 5 shows normalized data of FIG. 4.

FIG. 6 shows a CDF obtained from data of FIG. 5.

FIG. 7 shows a normalized CDF plot.

FIG. 8 shows a CDF from a simulated base station deployment.

FIG. 9 shows a second CDF from a simulated base station deployment.

FIG. 10 shows a third CDF from a simulated base station deployment.

FIG. 11 shows a PN Generator functional block.

FIG. 12 shows a functional schematic of a linear feedback shift register based PN generator with default seeding at start of cycle.

FIG. 13 shows binary representations of BSIC codes 90 and 1147 and a common PN generator seeded with BSIC 90.

FIG. 14 shows Transmit power weighting of LTE Physical Resource Blocks based on a seeded PN generator.

FIG. 15 shows a process for channel assignment.

FIG. 16 shows an initial channel pool.

FIG. 17 shows a first power schedule.

FIG. 18 shows a second power schedule.

FIG. 19 shows a third power schedule.

FIG. 20 shows a channel assignment for Cell A according to the third power schedule.

FIG. 21 shows a channel assignment for Cell B according to the second power schedule.

FIG. 22 shows a channel assignment for Cell C according to the first power schedule.

FIG. 23 shows channel allocation to UE.

FIG. 24 shows an embodiment of a process for interference reduction.

FIG. 25 shows an embodiment of functional block architecture of a system for usage-aware interference mitigation scheduling.

FIGS. 26 and 27 illustrate embodiments of usage-aware interference mitigation scheduling.

FIG. 28 illustrates three different resource power allocations.

FIGS. 29A and 29B show process for coordinated power scheduling.

FIG. 30 shows an example of a power schedule assigned to frequency resources at a single eNodeB.

FIG. 31 shows an example assignment of fixed phases preferentially assigned to higher power resources.

FIG. 32 shows an example assignment of fixed phases to power scheduled resources.

FIGS. 33A and 33B show an example of two signals with different power levels being received at a mobile station receiver.

FIG. 34 shows a plot of the power gain of the combined signals, versus the phase difference of two signals at a receiver.

FIG. 35 shows the gain vs. phase difference when there is a 3 dB imbalance in the signal levels arriving at the receiver.

FIG. 36—Different Precoding Matrix in each TTI from interference source

FIGS. 37A and 37B—Same Precoding Matrix in each TTI from interference source.

### DETAILED DESCRIPTION

In the following description, neighbor tiers are related to coverage area boundaries. In particular, two neighboring cells are first tier neighbors when their respective coverage areas share a common cell boundary. In addition, second tier neighbors have coverage areas that are separated by one other cell, while third tier neighbors have coverage areas that are separated by two other cells, and so on. This explanation is consistent with expectations from RF engineers for tier relationships.

This disclosure provides a method and system for determining the number of tiers separating cells in a cellular communications network. This information can then be used in algorithms for self-organizing networks, such as Automatic Neighbor Relations (ANR), Neighbor List Initialization, Coverage and Capacity Optimization (CCO), Reuse Code Optimization (e.g., Scrambling Code Optimization for UMTS networks, PCI Optimization for LTE Networks, BSIC optimization for GSM networks, etc.). Various cellular parameters may be changed in conjunction with these activities, such as transmit power and antenna tilt and direction.

A detailed description of embodiments is provided below along with accompanying figures. The scope of this disclosure is limited only by the claims and encompasses numerous alternatives, modifications and equivalents. Although steps of various processes are presented in a particular order, embodiments are not necessarily limited to being performed in the listed order. In some embodiments, certain operations may be performed simultaneously, in an order other than the described order, or not performed at all.

Numerous specific details are set forth in the following description in order to provide a thorough understanding. These details are provided for the purpose of example and embodiments may be practiced according to the claims without some or all of these specific details. For the purpose of clarity, technical material that is known in the technical fields related to this disclosure has not been described in detail so that the disclosure is not unnecessarily obscured.

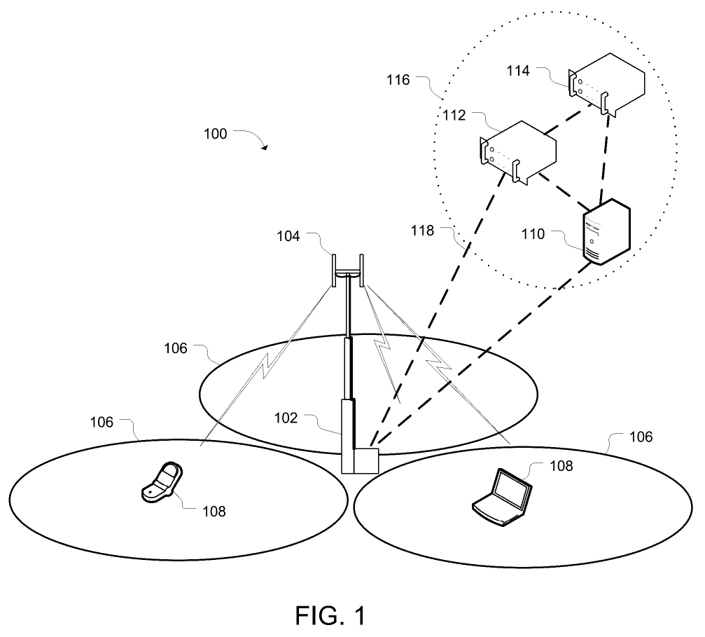

FIG. 1 illustrates a networked communications system 100 according to an embodiment of this disclosure. System 100 may include one or more base stations 102, each of which are equipped with one or more antennas 104. Each of the antennas 104 may provide wireless communication for user equipment 108 in one or more cells 106. As used herein, the term “base station” refers to a wireless communications station provided in a location and serves as a hub of a wireless network. For example, in LTE, a base station may be an eNodeB. The base stations may provide service for macrocells, microcells, picocells, or femtocells. In this disclosure, the term “cell site” may be used to refer to the location of a base station.

The one or more UE 108 may include cell phone devices, laptop computers, handheld gaming units, electronic book devices and tablet PCs, and any other type of common portable wireless computing device that may be provided with wireless communications service by a base station 102. In an embodiment, any of the UE 108 may be associated with any combination of common mobile computing devices (e.g., laptop computers, tablet computers, cellular phones, handheld gaming units, electronic book devices, personal music players, MiFi™ devices, video recorders, etc.), having wireless communications capabilities employing any common wireless data communications technology, including, but not limited to: GSM, UMTS, 3GPP LTE, LTE Advanced, WiMAX, etc.

The system 100 may include a backhaul portion 116 that can facilitate distributed network communications between backhaul equipment or network controller devices 110, 112 and 114 and the one or more base station 102. As would be understood by those skilled in the Art, in most digital communications networks, the backhaul portion of the network may include intermediate links 118 between a backbone of the network which are generally wire line, and sub networks or base stations located at the periphery of the network. For example, cellular user equipment (e.g., UE 108) communicating with one or more base station 102 may constitute a local sub network. The network connection between any of the base stations 102 and the rest of the world may initiate with a link to the backhaul portion of a provider's communications network (e.g., via a point of presence).

In an embodiment, the backhaul portion 116 of the system 100 of FIG. 1 may employ any of the following common communications technologies: optical fiber, coaxial cable, twisted pair cable, Ethernet cable, and power-line cable, along with any other wireless communication technology known in the art. In context with various embodiments, it should be understood that wireless communications coverage associated with various data communication technologies (e.g., base station 102) typically vary between different service provider networks based on the type of network and the system infrastructure deployed within a particular region of a network (e.g., differences between GSM, UMTS, LTE, LTE Advanced, and WiMAX based networks and the technologies deployed in each network type).

Any of the network controller devices 110, 112 and 114 may be a dedicated Network Resource Controller (NRC) that is provided remotely from the base stations or provided at the base station. Any of the network controller devices 110, 112 and 114 may be a non-dedicated device that provides NRC functionality among others. In another embodiment, an NRC is a Self-Organizing Network (SON) server. In an embodiment, any of the network controller devices 110, 112 and 114 and/or one or more base stations 102 may function independently or collaboratively to implement processes associated with various embodiments of the present disclosure.

In accordance with a standard GSM network, any of the network controller devices 110, 112 and 114 (which may be NRC devices or other devices optionally having NRC functionality) may be associated with a base station controller (BSC), a mobile switching center (MSC), a data scheduler, or any other common service provider control device known in the art, such as a radio resource manager (RRM). In accordance with a standard UMTS network, any of the network controller devices 110, 112 and 114 (optionally having NRC functionality) may be associated with a NRC, a serving GPRS support node (SGSN), or any other common network controller device known in the art, such as an RRM. In accordance with a standard LTE network, any of the network controller devices 110, 112 and 114 (optionally having NRC functionality) may be associated with an eNodeB base station, a mobility management entity (MME), or any other common network controller device known in the art, such as an RRM.

In an embodiment, any of the network controller devices 110, 112 and 114, the base stations 102, as well as any of the UE 108 may be configured to run any well-known operating system, including, but not limited to: Microsoft® Windows®, Mac OS®, Google® Chrome®, Linux®, Unix®, or any mobile operating system, including Symbian®, Palm®, Windows Mobile®, Google® Android®, Mobile Linux®, etc. Any of the network controller devices 110, 112 and 114 or any of the base stations 102 may employ any number of common server, desktop, laptop, and personal computing devices.

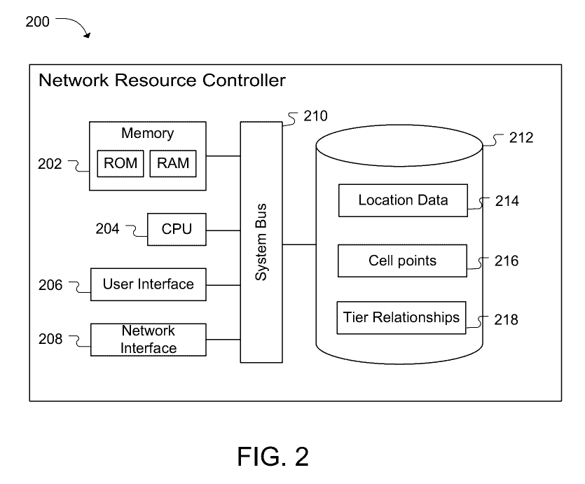

FIG. 2 illustrates a block diagram of an NRC 200 that may be representative of any of the network controller devices 110, 112 and 114. Accordingly, NRC 200 may be representative of a Network Management Server (NMS), an Element Management Server (EMS), a Mobility Management Entity (MME), or a SON server. The NRC 200 has one or more processor devices including a CPU 204.

The CPU 204 is responsible for executing computer programs stored on volatile (RAM) and nonvolatile (ROM) memories 202 and a storage device 212 (e.g., HDD or SSD). In some embodiments, storage device 212 may store program instructions as logic hardware such as an ASIC or FPGA. Storage device 212 may store, for example, location data 214, cell points 216, and tier relationships 218.

The NRC 200 may also include a user interface 206 that allows an administrator to interact with the NRC's software and hardware resources and to display the performance and operation of the system 100. In addition, the NRC 200 may include a network interface 208 for communicating with other components in the networked computer system, and a system bus 210 that facilitates data communications between the hardware resources of the NRC 200.

In addition to the network controller devices 110, 112 and 114, the NRC 200 may be used to implement other types of computer devices, such as an antenna controller, an RF planning engine, a core network element, a database system, or the like. Based on the functionality provided by an NRC, the storage device of such a computer serves as a repository for software and database thereto.

Transmission Power Level Coordination with Automatic Determination of Target Thresholds

Embodiments of the present disclosure relate to U.S. Pat. No. 8,379,574, SYSTEMS AND METHODS FOR MITIGATING INTERCELL INTERFERENCE BY COORDINATED SCHEDULING AMONGST NEIGHBORING CELLS, the contents of which are incorporated by reference. U.S. Pat. No. 8,379,574 discloses a power scheduling function that utilizes a “Target CINR” when optimizing the power allocations across a cluster of base station nodes. The Target CINR (Carrier to Interference plus Noise Ratio) is a fixed value that may vary from cluster to cluster. Embodiments of the present disclosure relate to an automated method for determining a target CINR based on the CINR measurements reported by Customer Premises Equipment (CPE).

In an automated process for determining a CINR threshold, the Cumulative Distribution Function (CDF) of the CPE CINR values is calculated. This calculation is performed by first binning the CINR measurements into a histogram to generate the Probability Distribution Function (PDF) of the CINR measurements. Next the PDF bin values are added in a cumulative manner to generate the CDF. The CDF can be optionally normalized by dividing each CDF value by the total number of CPE CINR measurements.

The target CINR is then selected as a particular percentile value from the CDF. For example, the CINR may be chosen as the 50^{th} percentile value, equivalent to the median value of the CINRs. In another embodiment, another percentile value may be chosen.

Previously the power scheduling function made use of a target CINR that was used for all scenarios. Testing and simulation has established that a single target CINR is not suitable for all situations. Additional research suggests that if the target CINR was selected as a particular percentile of the CINR values from all the CPE devices then the optimization process performs better across a much wider set of situations.

Simulations performed on the interference minimizing scheduler show that optimal performance for the simulated system is achieved when the target CINR is set to the 35th percentile value. Other simulations or field data may show that an alternate percentile value is more appropriate for other situations.

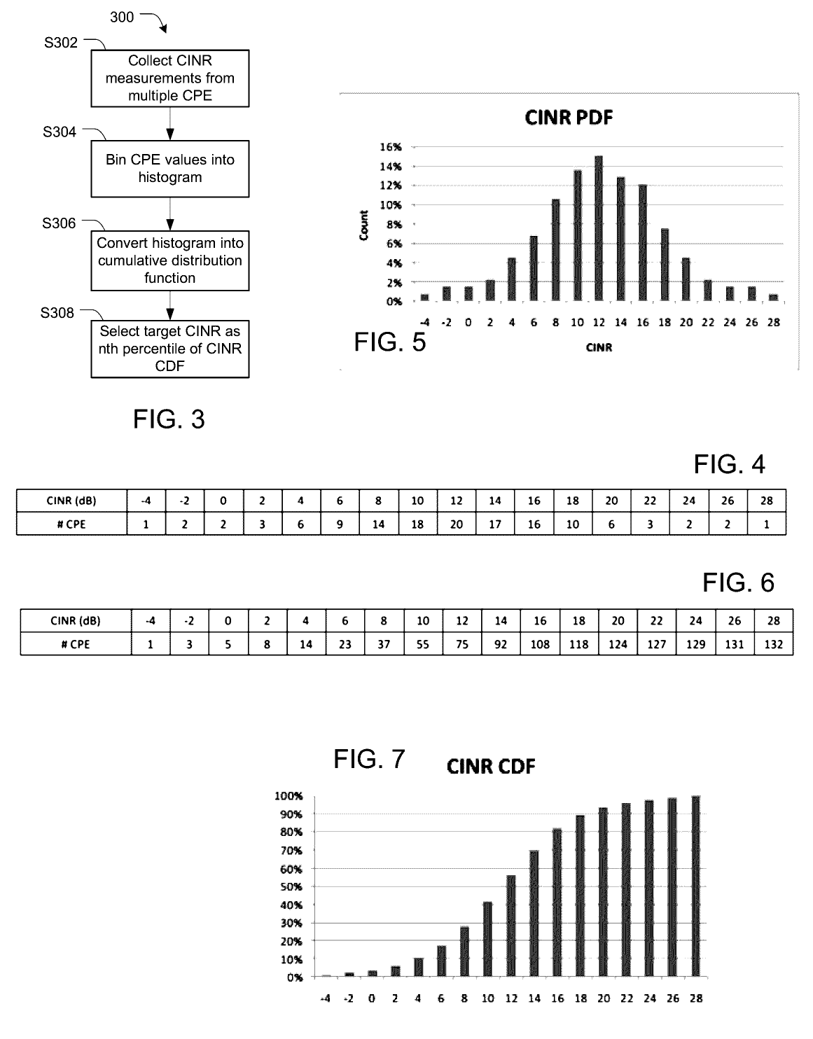

FIG. 3 shows a process 300 for automatically determining a target CINR threshold.

At S302, the CINR data from multiple CPEs is gathered. At 5304, the CINR data is binned into a histogram. A bin size for this histogram may be 1 dB, although smaller bin sizes (e.g., 0.5 dB) or larger bin sizes (e.g., 2 dB) can also be used in other embodiments. Alternatively, the number of bins in the histogram can be fixed (e.g. 50 bins) and the bin sizes can be determined from the maximum and minimum CINR values in the collected set of CINR data.

The histogrammed data is converted into a cumulative distribution function at 5306. The CDF is obtained by keeping a running total of the histogram data bins. As an example, assuming that 132 CPEs report their CINRs, the histogram bins are as shown in FIG. 4.

The data in the above table is normalized by dividing by the total number of CPEs and plotted in FIG. 5. The CDF obtained from FIG. 5 is shown in FIG. 6.

The elements in the CDF table are obtained from the PDF table by adding together all the PDF table entries for CINRs less than or equal to the CINR in the CDF table. The normalized CDF plot is shown in FIG. 7.

At S308, the target CINR is selected as a particular percentile from the CDF. There are several ways in which the target CINR corresponding to a percentile can be obtained from the CDF. The following is a non-exhaustive list of some of those ways:

1. Choose the lowest CINR where the CDF is greater than or equal to the percentile.
2. Choose the highest CINR where the CDF value is less than or equal to the percentile.
3. Choose the CINR where the CDF value is closest to the percentile.
4. Calculate the average (mean) of the two CINRs that are both above and below the percentile.
5. Linearly interpolate the CDF values of the two CINRs that are both above and below the percentile and estimate the 50^{th} percentile based on the linear interpolation.

For the plot shown in FIG. 7, and assuming a target percentile of 50%, the target CINR corresponding to each of the above process is:

1. 12 dB (CDF value=56.8%)
2. 10 dB (CDF value=41.7%)
3. 12 dB (difference=6.8%)
4. Simple average=11 dB (=(10 dB+12 dB)/2).
5. Linear interpolation=11.1 dB (=10 dB+(12 dB−10 dB)*(50%−41.7%)/(56.8%−41.7%))

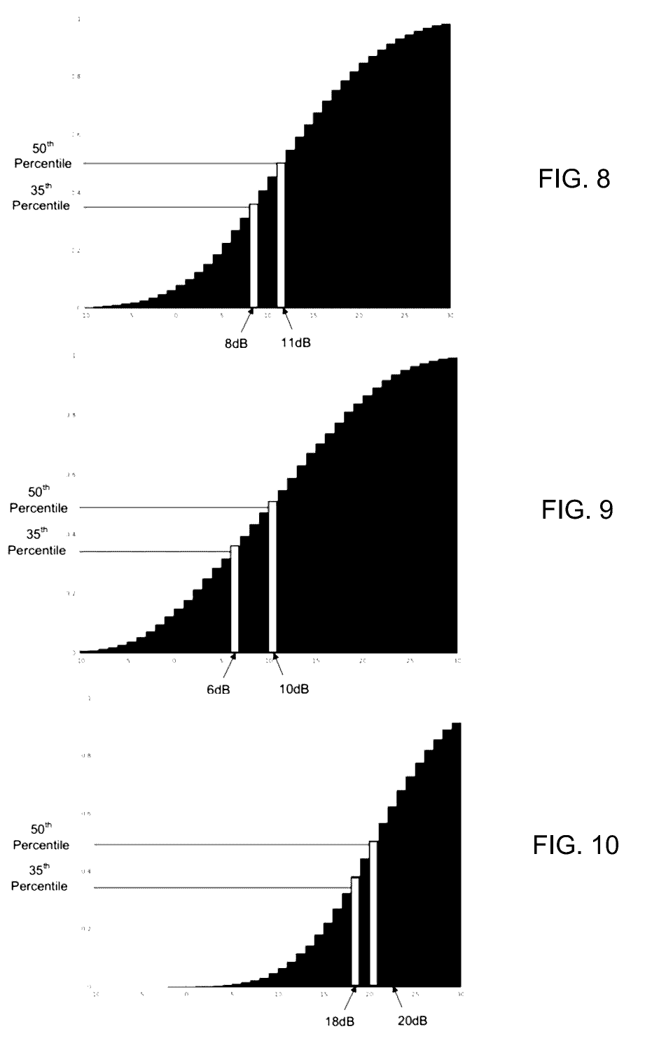

FIG. 8 shows a CDF from a simulated base station deployment. In the embodiment of FIG. 8, CINR values have been placed into 1 dB bins. For simplicity in this case, we choose the target CINR as the bin in which the CDF is greater than or equal to the target percentile. Based on this rule, the 50th percentile CINR is chosen as 11 dB and the 35th percentile CINR is chosen as 8 dB.

FIG. 9 shows a second CDF from a different simulated base station deployment. In the embodiment of FIG. 9 the 50th percentile CINR is chosen as 11 dB and the 35th percentile CINR is chosen as 8 dB using the same rule for choosing the CINR as above

FIG. 10 shows a third CDF from (yet another) different simulated base station deployment. In the embodiment of FIG. 10, the 50th percentile CINR is chosen as 20 dB and the 35th percentile CINR is chosen as 18 dB using the same rule for choosing the CINR as discussed above.

### Interference Estimation in Power Scheduled Network

In a power-scheduled network, where the transmit power of each base station varies according to a pre-determined or a dynamic schedule, the CINR (Carrier to Interference and Noise Ratio) observed at each UE (User Equipment) depends on channel conditions and on the transmit power of the serving base station and of the neighbor base stations.

An embodiment of this disclosure improves the estimate of CINR for each UE when the transmit power at base stations varies across time and frequency resources.

In a network in which the transmit power of each base station is adjusted according to an optimized schedule, the CINR observed at a given UE will vary across time and frequency resources depending on the schedule and also depending on the time/frequency resources being used: the CINR will be degraded if the serving base power is reduced, or if one or more of the neighbor cells' power is increased on a particular time/frequency resource; the CINR will be enhanced if the serving base power is increased, or if one or more of the neighbor cells' power is decreased on a time/frequency resource.

When scheduling data transmissions, it is helpful to know what is the optimal modulation and coding scheme that can be used on a particular time and frequency resource. There is generally a mapping between the CINR seen on that time/frequency resource and the optimal modulation and coding scheme that can be used on that time/frequency resource.

Therefore, one of the conditions for optimal network performance is the ability to measure or estimate the CINR at each UE on each time and frequency resource, especially in systems where the transmit power of the base stations changes across time and frequency resources.

In LTE, the UEs periodically measure the channel quality and report it to the serving base with a CQI (Channel Quality Indication). This metric is based on cell-specific reference signals, and does not reflect changes due to the variation in transmit power across time and frequency resources.

In LTE, the UE can also periodically measure the neighbor cell signal RSRP (Reference Signal Received Power) and RSRQ (Reference Signal Received Quality) and report these to the serving base station. These metrics are also based on cell-specific reference signals, and do not reflect the impact of power scheduling across time and frequency resources.

An embodiment allows an eNodeB in an LTE system to estimate the CINR on particular time and frequency resources at a UE by combining:
The UE's CQI measurement reports,
The UE's RSRP measurement reports, and
Knowledge at the base station regarding the power scheduler of both the serving base and its neighbors.

An estimate of the carrier power is given by the CQI. Depending on the configuration of the CQI measurement, this may be a signal measure that is an average of the channel quality over the whole operating spectrum, or may be multiple measurements taken over subsets of PRBs (Physical Resource Blocks) of the whole spectrum according to the following Equation 1:

C(resource)≈CQI(resource(prb))*ScheduledTxPower(resource,serving base) [Equation 1]

Here, resource indicates a particular block of OFDM subcarriers in time and frequency, and corresponds to the power scheduler's configuration. ScheduledTxPower (resource, base) thus is the transmit power of a particular base station on a particular resource.

An estimate of the interference power is obtained by calculating the sum of the RSRPs weighted by the scheduled transmit power of each of the neighbor base stations according to the following Equation 2:

$$I ( resource ) \approx {\sum }_{n = neighbor base} RSRP ( n ) * ScheduledTx Power ( resource , n ) \qquad [ Equation 2 ]$$

An estimate of the CINR is given by Equation 3:

$$CINR ( resource ) = \frac{C ( resource )}{I ( resource ) + Noise} \qquad [ Equation 3 ]$$

In Equation 3, Noise can be a known constant such as 6 dB.

This CINR estimate can then be used to make decisions for scheduling data, allocation of power schedules, etc.

An embodiment is used in a base station scheduler to identify optimal UE candidates, depending on the power schedule and on the measured channel conditions, and thus provides improvements in network efficiency and capacity.

This technique can also be used in more traditional cellular network schemes such as FFR (Fractional Frequency Re-Use), provided that the neighbor re-use pattern is known, or can be determined.

Embodiments of this disclosure provide a method for estimating CINR in a power-scheduled cellular environment, a method for improved weighted proportional fair scheduler, and a method for improved cellular network scheduler.

### Wireless Network Interference Reduction Via Locally Generated Pseudorandom Power Schedules

This disclosure provides a process for provisioning channel schedules to wireless network base stations such that transmit power and/or phase is varied in a controlled manner to reduce adjacent cell interference levels. This disclosure provides a simple method of locally determining appropriate transmit power levels to individual time and frequency resources in a pseudorandom manner across neighboring wireless base stations. The method described in this disclosure allows each wireless base station to estimate the varying interference levels on each time and frequency resource from neighboring base stations to each network user such that appropriate channels can be assigned yielding higher network throughput and improved coverage reliability in interference limited networks.

The methods described in this disclosure do not rely on real time communication of the channel randomization scheme but provide a mechanism for each base station to locally determine both its own channel randomization schedule as well as those of neighboring base stations thereby removing the requirement for real time centralized schedule information distribution or base to base communication links to carry this information.

Wireless access networks utilize a fixed set of time/frequency channels to carry user data to individual network subscribers. Commercial demands on network data throughput coupled with costly and limited radio frequency spectrum all but force system operators to reuse channel resources at as many wireless base stations or cells as possible. This approach of universal reuse allows all base stations to use all licensed channels and offers the potential for very high network data throughput, but also creates the potential for high levels of adjacent cell interference in heavily loaded systems as nearby cells simultaneously allocate the same channels. In addition to raising interference levels that force data to be carried in less efficient modulation modes this also leads to poor coverage reliability to cell edge users located far from their serving base station.

Various schemes, such as fractional frequency reuse, have been defined for broadband OFDM systems where a portion of the available channels are allocated universally to all cells and portions of the overall channel pool are restricted such that near neighbor cells do not simultaneously utilize these channels. This approach is effectively a compromise between traditional static reuse planning and universal frequency reuse and as such offers a compromise in terms of data throughput and coverage reliability. The overall efficiency in terms of network data throughput and spectrum utilization is limited by pre provisioned fractional channel blocks that assume steady loading levels between the neighboring cells. In essence, a portion of the overall channel pool is set aside and not utilized at each cell such that coverage reliability to cell edge users is assured regardless of actual loading patterns or propagation environments.

Various interference limiting approaches have been offered that leverage the transmitted power and/or phase characteristics at each cell site to reduce interference levels between adjacent cells utilizing the same channels. These soft-fractional frequency reuse schemes fall into two groups:
1. Those that pre provision static channel sub blocks for reuse across neighboring cells, and
2. Those that utilize close loop feedback systems to automatically optimize channel distribution in frequency, time, power or transmit phase such that interference is reduced in accordance with dynamic system loading and RF propagation.

These latter approaches offer the highest overall network performance in terms of both data throughput and coverage reliability but require additional network processes and/or components to carry out the closed loop optimization tasks. In either case the goal is to increase the probability of allocating channels to users with acceptably low levels of interference such that coverage is assured across the operating region and data can be reliably transferred using higher data rate modulation and coding schemes.

Embodiments of this disclosure reduce overall system interference without placing restrictions on access to portions of the channel pool (e.g. fractional frequency reuse) or resorting to complex closed loop adaptation processes.

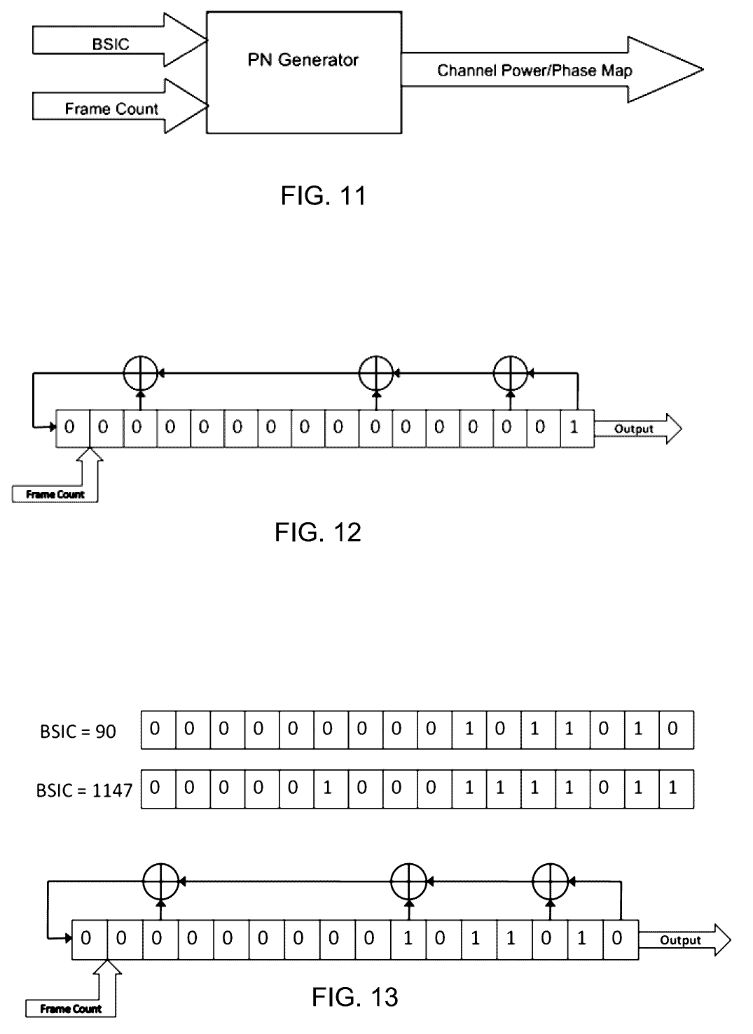

The interference reduction method presented here associates a transmit power back off level to each channel in the overall channel pool ranging from 0 dB (i.e. full power with no back off) to a provisionable limit of P_min dB in a provisionable number of total power backoff levels (e.g. 4 levels of 3 dB each). Each channel in the overall pool is assigned a power weighting based on a known pseudorandom sequence defined for all cells in the system but seeded with a base station specific number sequence derived from unique information such as the cellular Base Station Identification Code (BSIC), as well as a timing offset value derived from known system wide timing information such as frame or sub-frame indexing information. The seeded Pseudorandom Number (PN) generator used to modify sub-channel power levels is shown in FIG. 11.

The PN Generator functional block shown in FIG. 11 represents a deterministic function common to all wireless base stations that generates a known pseudorandom number sequence. There are many commonly used signal processing functions that perform this task, but one example includes the use of a linear feedback shift register with appropriate feedback taps as shown generically in FIG. 12.

FIG. 12. shows a functional schematic of a linear feedback shift register based PN generator with default seeding at start of cycle. With each successive increment of the frame count clock the bits within the register are shifted to the right with the right most bit (shown as ‘1’ with the default start of cycle seeding) is shifted to the output. Each of the tapped bits shown with the vertical arrows is summed via modulo two arithmetic (e.g. a logical XOR operation) and the bit representing the logical sum of these operations is fed back to the left most position of the shift register. By appropriate choice of feedback taps and overall register length a pseudorandom output sequence of binary bits is produced through successive shifting of register bits in response to the shift clock shown as Frame Count in FIG. 12.

A well designed PN generator of this type may demonstrate the following properties:
The output PN sequence will repeat every 2 L−1 clock cycles where L represents the shift register length. The 16 bit register example shown above will produce a sequence of 65535 output bits before repeating the same sequence.
The output sequence will have approximately the same number of output ones and zeros.
The output sequence will have approximately equal occurrence of bit ‘runs’ of arbitrary length. That is the number of consecutive bits of the same magnitude will occur with roughly equal frequency throughout the distribution so that the occurrence of consecutive sequences of zeros or consecutive ones will be approximately random.
The sequence will appear random and ‘noise like’ across an arbitrary sample of its overall length. This implies that suitable sub-sections of the sequence will be statistically decorrelated to one another such that for example a selection of 100 output bits taken from randomly chosen different points in the overall sequence will have not been strongly correlated to one another.
All possible combinations of ones and zeros possible within the defined shift register length (i.e. 16 for the design shown in FIG. 2) will be represented at points within the overall sequence with the exception of the null case of all zeros.
The null seed of all zeros into the generator shift register will cause all subsequent output bits to remain zero for all future transitions of the shift register clock.

Based on these properties, in particular the fact that all possible combinations of ‘L’ bits, excepting the null case of all zeros, is present at some point in the overall sequence it is possible to ‘seed’ the sequence with an arbitrary sequence of ‘L’ bits which is effectively the same as starting the sequence with the default seed shown in FIG. 2 (a single ‘1’ bit in the right most register) and clocking the sequence forward by a given number of clock cycles. In other words, seeding a well designed sequence with an arbitrary sequence of ‘L’ bits simply shifts the output to a fixed offset relative to the cyclic start of the default sequence. This property allows the same sequence generator to be seeded with base station unique information such that it continues to produce the same overall output sequence with a fixed offset in time.

An embodiment relies on that property so that the same global PN generating function is known to all base stations within the system as is the absolute frame count based on system time synchronization boundaries. By seeding the sequence with base station specific data that fills the PN generator shift register such as a unique ‘L’ bits derived from the Base Station Identification Code (BSIC) each base station will be able to locally generate its own sequence with appropriate offset as well as the sequence of other nearby base stations simply by seeding their known BSIC values into the common PN generator. This is shown in FIG. 13.

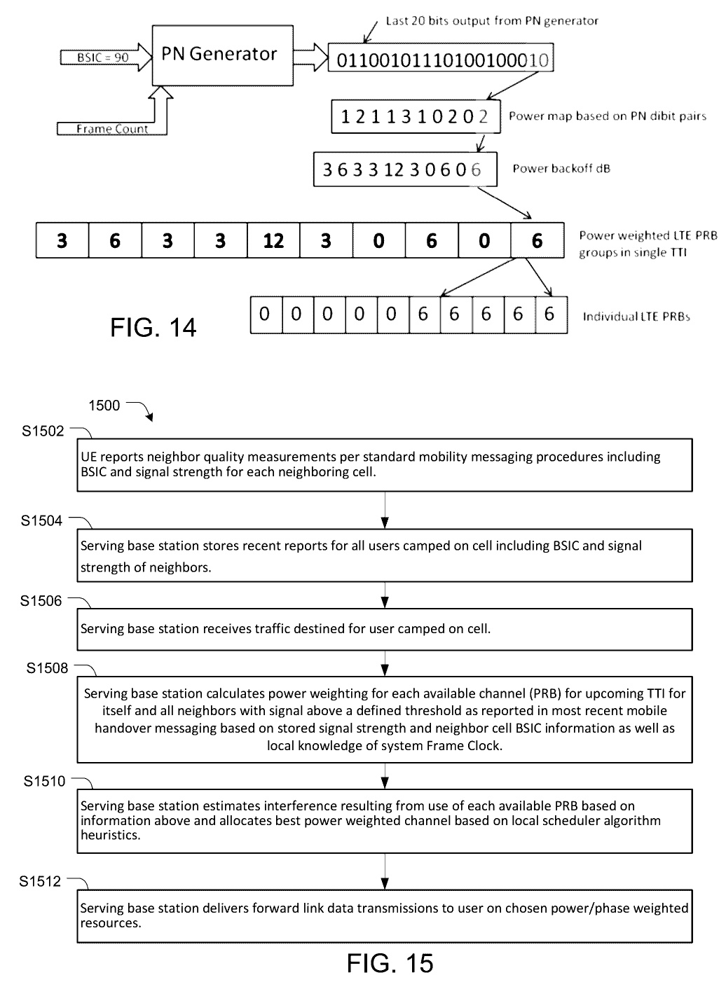

FIG. 14 illustrates the process of using system Frame Count timing along with a unique BSIC code to generate an offset into a globally known PN sequence and using a section of the output sequence to determine appropriate transmit power weighting for LTE sub channels.

The process used to assign transmit power weighting to a given base station's PRBs based on system clock and BSIC also allows base stations to know what power weightings nearby base stations will utilize for each PRB on subsequent transmissions based only on the globally known system clock and the unique identification of each neighboring base station. Base station identification codes are available to all users within the network and are broadcast on each cell's broadcast channel to support network mobility and handover between cells and is thus both known by each piece of user equipment and reported as a standard part of handover messaging.

Thus by defining a global PN generating sequence and utilizing existing system measurement and messaging procedures designed for initial connectivity and mobility support it is possible for each base station to both randomize their power transmission levels for each sub channel (i.e. PRB) over time and to simultaneously have knowledge of the transmission level applied by each neighboring base station for current and future transmissions. This allows each base station to estimate signal to interference ratios that each user will experience during upcoming transmissions and allocate the best available resources to both satisfy the individual user's link and to minimize excessive interference into neighboring cells. Across a group of cells this reduces net interference, increases net data throughput and increases overall coverage reliability. An embodiment of a process 1500 for channel assignment using this method is shown in FIG. 15.

For simplicity the examples above demonstrated this method for the application of transmit power level weighting but other parameters such as multiple antenna transmit phase could also be decorrelated for the purpose of interference reduction and collision avoidance using the same basic principles. Additionally, other methods of generating random sequences such as linear congruential generator, Mersenne Twister, etc, can be used in place of the Linear Feedback Shift Register approach described in this disclosure.

In an embodiment, a system automatically optimizes the utilization of wireless network airlink resources such that interference is reduced, coverage reliability is increased and overall network throughput is increased.

Embodiments of the present disclosure include a method for reducing radio frequency interference levels in wireless networks without relying on central coordination or base to base communication methods, a method for pre provisioning channel pools to wireless base stations allowing universal access to available channels but constrained by power backoff levels and/or specific transmit phasing of multiple antennas, a method for allocating power constrained channels to appropriate users based on local link conditions, and a method for utilizing pseudorandom number generators to weight physical layer resources with power and/or phase information.

### Wireless Network Interference Reduction Via Pseudorandom Power Schedules

This disclosure describes a method of provisioning channel schedules to wireless network base stations such that transmit power is varied in such a way as to reduce the probability of adjacent cell interference. An embodiment provides a simple and statically provisioned method of assigning transmit power levels to individual time and frequency resources in a pseudorandom manner across neighboring wireless base stations such that the probability of interference from neighboring cells is reduced, leading to higher levels of coverage reliability and higher network throughput.

Wireless access networks utilize a fixed set of time/frequency channels to carry user data to individual network subscribers. Commercial demands on network data throughput coupled with costly and limited radio frequency spectrum all but force system operators to reuse channel resources at as many wireless base stations or cells as possible. This approach of universal reuse allows all base stations to use all licensed channels and offers the potential for very high network data throughput but also creates the potential for high levels of adjacent cell interference in heavily loaded systems as nearby cells simultaneously allocate the same channels. In addition to raising interference levels that force data to be carried in less efficient modulation modes this also leads to poor coverage reliability to cell edge users located far from their serving base station.

Various schemes such as fractional frequency reuse have been defined for broadband OFDM systems where a portion of the available channels are allocated universally to all cells and portions of the overall channel pool are restricted such that near neighbor cells do not simultaneously utilize these channels. This approach is effectively a compromise between traditional static reuse planning and universal frequency reuse and as such offers a compromise in terms of data throughput and coverage reliability. The overall efficiency in terms of network data throughput and spectrum utilization is limited by pre provisioned fractional channel blocks that assume steady loading levels between the neighboring cells. In essence, a portion of the overall channel pool is set aside and not utilized at each cell such that coverage reliability to cell edge users is assured regardless of actual loading patterns or propagation environments.

Various interference limiting approaches have been offered that leverage the transmitted power and/or phase characteristics at each cell site to reduce interference levels between adjacent cells utilizing the same channels. These soft-fractional frequency reuse schemes generally fall into two groups:

1. Those that pre provision static channel sub blocks for reuse across neighboring cells, and
2. Those that utilize close loop feedback systems to automatically optimize channel distribution in frequency, time, power or transmit phase such that interference is reduced in accordance with dynamic system loading and RF propagation.

These latter approaches offer the highest overall network performance in terms of both data throughput and coverage reliability but use additional network processes and/or components to carry out the closed loop optimization tasks. In either case the goal is to increase the probability of allocating channels to users with acceptably low levels of interference such that coverage is assured across the operating region and data can be reliably transferred using high data rate modulation and coding schemes.

An embodiment of this disclosure reduces overall system interference without placing restrictions on access to portions of the channel pool (e.g. fractional frequency reuse) or resorting to complex closed loop adaptation processes.

An interference reduction method according to an embodiment associates a transmit power back off level to each channel in the overall channel pool ranging from 0 dB (i.e. full power with no back off) to a provisionable limit of P_min dB in a provisionable number of total power backoff levels (e.g. 4 levels of 3 dB each). Each channel in the overall pool is assigned a power weighting based on a pseudorandom sequence to create a defined number (e.g. 16) of unique and statistically decorrelated channel sets. Each of these channel sets is assigned to base stations in the network such that no two adjacent or overlapping cells utilize the same decorrelated channel set.

There are three primary mechanisms involved in an embodiment:
The creation of schedules with power attributes as illustrated below that are then distributed to base stations within the system,
The reporting from served user equipment of the potential quality of both individual frequency domain channels and the relative received signal strengths of neighboring base stations, and
The local assignment of an appropriate time and frequency channel to each served user based on the base station's knowledge of neighboring base station power attributed schedules and the information received from each served user. In other words, each base station assigns channels to served users after making a predictive signal quality estimation of available resources such that the best or most appropriate resources may be allocated to each served user. This estimation relies on knowledge of both the neighbor base station power schedules, as well as neighbor base station signal strength and channel quality estimates provided by each served user.

A distinction is made between the base station schedules with power attributes (power schedules) and the scheduling of packet data transmissions by the base station which results in a packet data schedule.

Power schedule creation with power attributes is described below. Each of these schedules is distributed among a group of neighboring base stations such that no two immediate neighbors share the same power schedule.

Channel pool decorrelation in terms of power backoff:

Number of channels in frequency: 20
Number of channels in time: 10
Total channel pool: 200
Power backoff range: 0-9 dB
Number of power backoff levels: 4
Power backoff values: 0 dB, −3 dB, −6 dB, −9 dB

In the following examples the power backoff levels were assigned to each frequency domain schedule resource (column of tables) based on a random number generator yielding one of four randomly chosen levels for each resource. The specifics of random number generation known and any of a number of standard approaches including feedback linear shift register or hash function approaches could be employed in various embodiments.

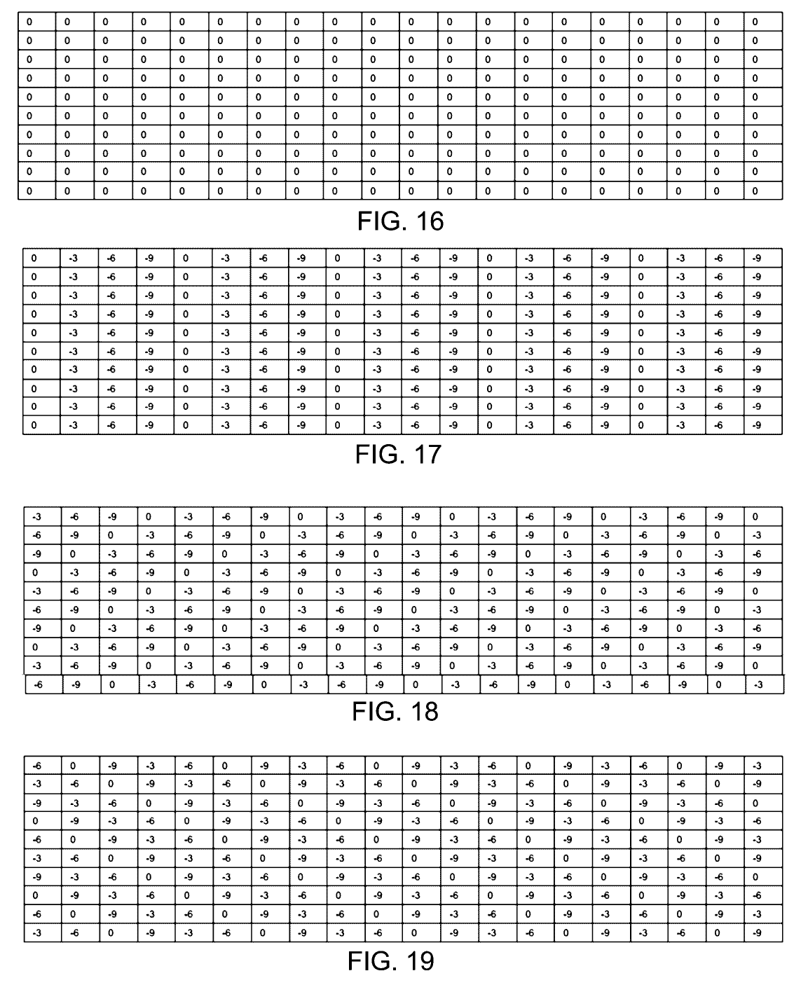

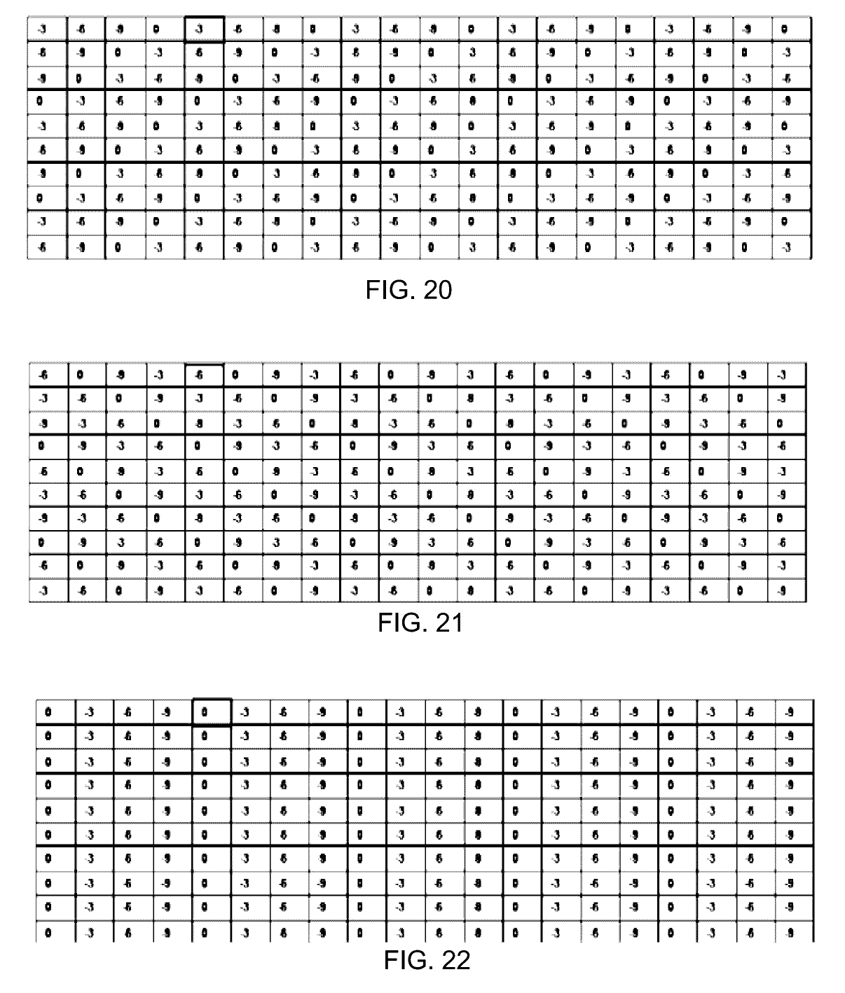

FIG. 16 shows an initial channel pool. FIG. 17 shows a first power schedule. FIG. 18 shows a second power schedule. FIG. 19 shows a third power schedule. FIG. 20 shows a channel assignment for Cell A according to the third power schedule. FIG. 21 shows a channel assignment for Cell B according to the second power schedule. FIG. 22 shows a channel assignment for Cell C according to the first power schedule.

Each UE measures and reports the quality of each frequency channel per customary mechanisms such as frequency domain CQI reporting defined for LTE networks. Additionally each UE reports the relative signal strength of each neighboring base station, again using existing measurement and reporting mechanisms such as those typically used to drive handover decisions in mobile networks. In this way each base station obtains information in terms of relative channel quality and an estimate of the isolation between each unique UE and the neighboring bases relative to signal strength and quality from the local serving base station.

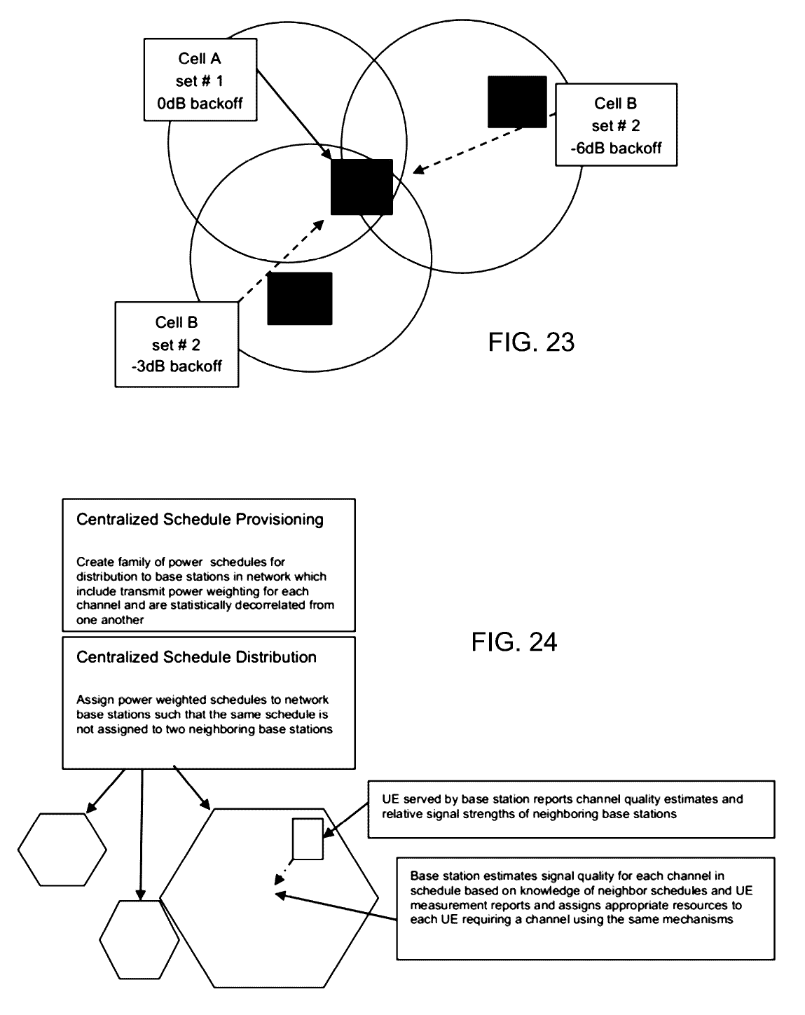

The packet data scheduler in each base station makes a channel quality estimate for each UE based on the reported relative signal strengths and frequency domain channel quality (e.g. CQI) reports combined with the base station's local knowledge of neighboring base stations per-channel transmit power schedules. This information is used to allocate appropriate channels to each user to both satisfy user network access and data throughput needs as well as to limit unnecessary interference to users in neighboring cells. The overall result is illustrated in FIG. 23.

In FIG. 23, Cell A allocates a particular time and frequency channel with 0 dB power backoff to a user (UE A) located near the cell edge that requires full power to successfully close the radio link. Cell B and Cell C allocate the same time and frequency channel to users that can successfully receive lower power signals (closer to cell center or favorable radio frequency propagation paths) with the power backoff levels dictated by the decorrelated power tables. Across the area of all three cells this approach statistically reduces radio frequency interference levels but does not prohibit any particular cells from using any of the available channels as long as the power backoff constraints are satisfied. An embodiment of a process for interference reduction via pseudorandom power schedules is shown in FIG. 24.

A system in any of its specific implementations may be used to automatically optimize the utilization of wireless network airlink resources such that interference is reduced, coverage reliability is increased and overall network throughput is increased.

### Method & System for Usage-Aware Interference Mitigation Scheduling

A central scheduling network element is able to plan non-overlapping OFDM resource block schedules between clusters of base stations in interference-limited scenarios. When considering the activity level of the individual user equipment terminals, the schedules can be optimized to improve the overall network efficiency and performance particularly in radio channel overload scenarios.

In wireless cellular deployments a typical outcome of limited spectrum is high level of frequency reuse between nearby cells. This has the tendency to create inter-cell interference and reduce the spectral efficiency of the shared channels used by the user equipment terminals.

In order to reduce this interference in OFDM networks the channel resource blocks can be partitioned according to base station downlink power levels so that they do not overlap in frequency and/or time between nearby base stations. User terminals can then be assigned into appropriate resource blocks according to their link conditions.

If terminal assignments are done without regard to the terminal activity level, a sub-optimal solution can result from terminals with comparatively little channel activity being assigned low-interference resources that could otherwise be better used by more active terminals.

This disclosure provides an embodiment of a system and set of methods by which a central or distributed interference coordination network element uses knowledge of user equipment terminal activity level to make informed selections of the best organization of channel resource block schedules.

The organization of non-overlapping resource blocks is performed in a manner where a weighting factor is determined based on activity and coding efficiency and applied so that the most active terminals tend to receive lower interference resources in situations where perfect interference isolation cannot be achieved for all terminals.

Operators need to obtain the highest efficiency from scarce radio spectrum in order to operate wireless networks economically and with greatest capacity. In a typical scenario the operator installs a multi-node radio resource controller (MNRRC) network element in their network. The MNRRC distributes non-overlapping power schedules to clusters of base stations considering both interference and terminal activity levels. The net effect is that the operator's overall network efficiency improves compared to networks without the MNRRC.

A multi-node radio resource controller (MNRRC) network element collects the radio signal quality and activity level from user terminal reports to the serving base station.

The MNRRC runs an algorithm to determine the non-overlapping transmit power requirements of each base station considering the most active and most interfered user terminals on a priority basis. The MNRRC distributes the resulting transmit power schedule to the base stations that can then use the power resource plan to schedule user terminals into the OFDM resources according to the terminals' signal power and bandwidth requirements. The net result is that user equipment terminals that most use the channel resources do so with higher efficiency thus improving the overall network efficiency.

An embodiment may perform the following operations:
1. Gather signal level and activity metrics from user equipment terminals.
2. Report interference and activity metrics to serving base station (activity metrics may alternatively be directly determined by the serving base station).
3. Base station gathers and sorts reports by highest interference and activity levels.
4. Base station sends metric reports to MNRRC.
5. MNRRC uses metric reports from clusters of base station to derive downlink power schedules using non-overlapping OFDM resources.
6. MNRRC distributes metric reports to base stations.
7. Base stations schedule user equipment terminals according to downlink power schedule and local fair-use scheduler.

Signal level metrics are carrier-to-interference-plus-noise (CINR) ratio corresponding to detected interfering base stations by each reporting user equipment terminal. Signal metrics may in some scenarios also include current modulation and coding level for each terminal.

Activity metrics are average throughput levels measured in an interval (e.g. 5 minutes) by active terminals. In some scenarios the activity levels could be reported in steps (low, medium, high) according to operator defined throughput thresholds. In other scenarios the activity could be reported as measured average throughput. In some embodiments the activity level may not be reported by the user terminals but instead by the serving base station that operates the bandwidth scheduler for the user terminals in its cell.

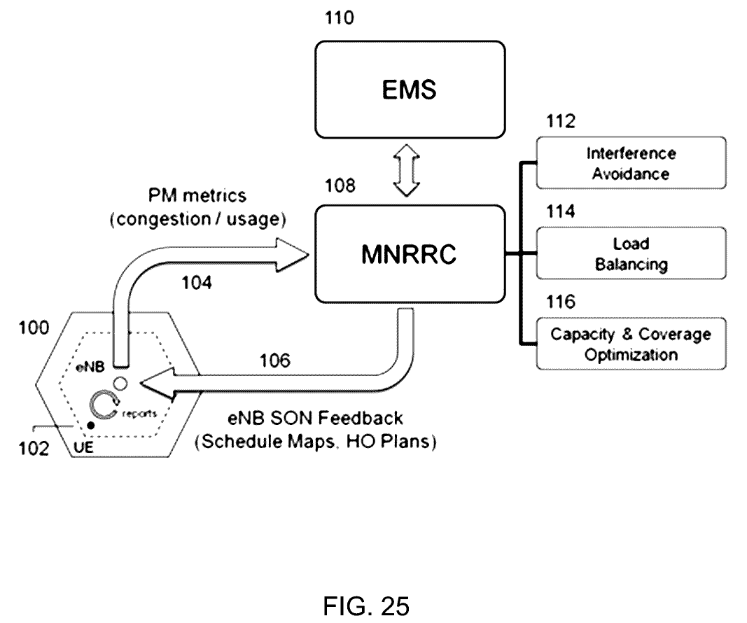

FIG. 25 shows an embodiment of the functional block architecture. In the figure one or a plurality of base stations (100) (e.g. eNodeB, Access Point, etc.) provides a wireless coverage cell for a plurality of user equipment terminals (102) able to report their radio environment conditions to the serving base station.

The base station (100) is communicatively linked to a multi-node radio resource controller (MNRRC) (108) that in the preferred embodiment is a centralized network core element communicating with a plurality of base stations, but could be a distributed function across the base stations. Performance metrics (104) are sent to the MNRRC (108) for the purpose of coordinating interference reducing schedules (106) that are distributed to the base stations (100).

The MNRRC (108) is composed of functional blocks for performing the resource scheduling for interference avoidance (112) but could perform other functions such as load balancing (114) or capacity and coverage optimization (116). The MNRRC (108) may be managed by a remote element management entity (110).

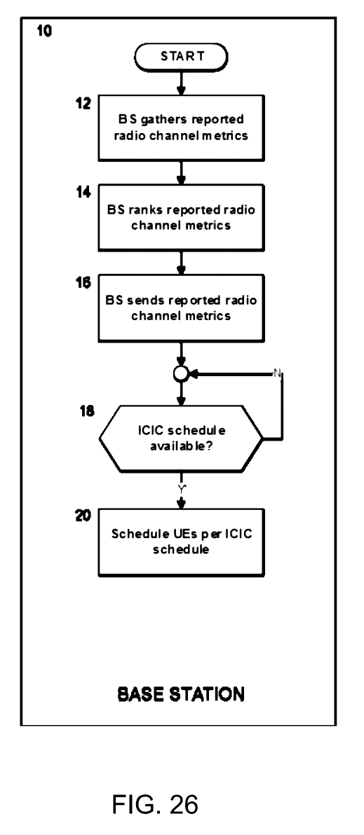

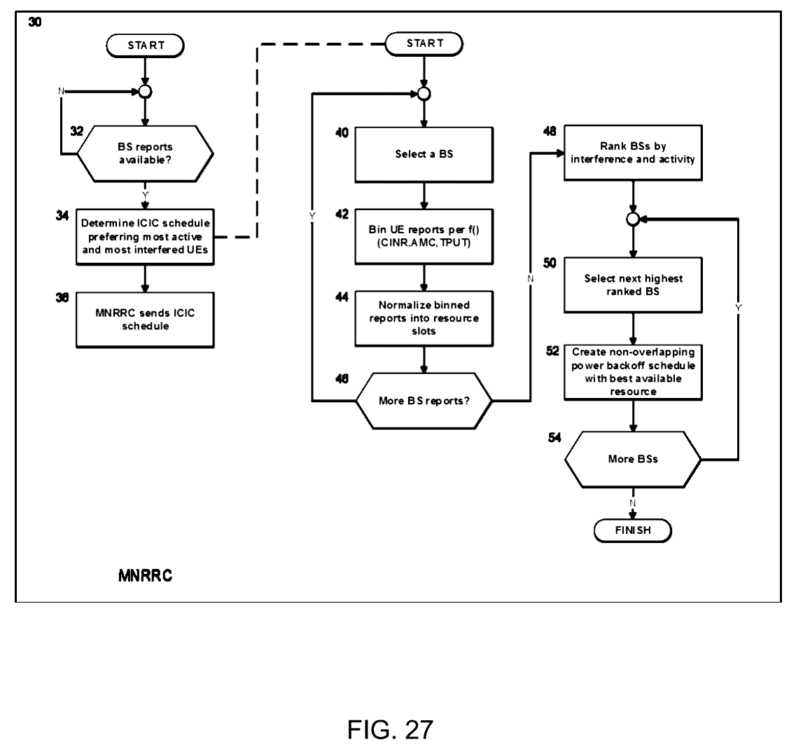

FIGS. 26 and 27 illustrate a process according to an embodiment. In the figure the primary flows are shown by major functional elements.

The base station flow (10) begins with the base station gathering reports (12) on the network radio conditions from the user equipment (UE) terminals. The base station ranks (14) the reported metrics according to a weighted combination of radio signal strength, interference signal strength, and terminal activity level. Terminal activity may be determined by the average throughput rate for the UE in an averaging interval. It is understood that idle terminals do not participate in the reporting. The base station sends the reported UE metrics (16) (or in some embodiments the highest ranking subset) to the MNRRC.

When an inter-cell interference coordination (ICIC) schedule is available (18) the base station uses the information to schedule its member UE's (20) on to the radio resources of the radio channel according to the interference avoidance rules. In some embodiments the ICIC schedule consists of power backoff rules for sets of OFDM time-frequency resource blocks.

The MNRRC flow (30) begins with metric reports available for a cluster of neighbor base stations (32). The MNRRC processes the metric reports (34) in order to arrive at the ICIC schedule for each of the reporting base stations in the cluster.

Once the ICIC schedule is formulated the MNRRC distributes the schedules (36) to the base stations in the cluster.

Procedure block (34) is further described by steps (40) to (54) as follows. A base station is selected from the reported list (40). In some embodiments the selected base station (40) is based on a rank ordering of the base stations choosing the most congested base stations first. Next, the previously received UE reports of the selected base station are grouped according to the reported radio and activity metrics (42) such as carrier to noise plus interference level (CINR), adaptive modulation and coding level (AMC), and activity level indicated by average throughput (TPUT). The counts (number of user terminals) in each reporting bin are normalized into a configured number of resource slots (44). If there are more reports to process (46) the sequence loops back to select another base station.

If there are no more reports to process (46) the base stations are ranked in order of the interference and then by the activity levels (48). From the ranked list the next base station is selected (50) and its UE reports are used to select the best resource slots from the pool of slots that will provide the best service of the base station with the least impact on its neighbors. If there are more base stations remaining in the ranked list (54) the process loops to select the next base station. If there are no more base stations in the list the process ends.

### Combined Phase and Power Coordinated Scheduling

An embodiment of this disclosure allows a phase coordinated scheduling scheme to be used in conjunction with a power coordinated scheduling scheme. The power coordination scheme can be statically or dynamically allocated to a network of base stations.

In one embodiment, the power coordination is first applied to the wireless network. Afterwards, the phase coordination is applied. In another embodiment, the phase coordination is first applied, then the power coordination is applied.

Simulations show that power coordinated scheduling can improve the overall capacity of a cellular network and/or the performance (throughput) of cell edge users of the cellular network. Power coordinated scheduling refers to techniques where the transmit powers of time and/or frequency radio channel resources managed by a base station or base station controller can be set to different levels and those levels are coordinated across one or more base stations.

Similarly, phase coordinated scheduling also provides gains in cell edge and overall capacity. Phase coordinated scheduling refers to techniques where some transmit resources at a base station are assigned a fixed transmit phase for all transmissions, while other resources are permitted to vary their phases for each transmission on those resources. The fixed transmit phase assignments can change over time. The assignment of fixed and dynamic phase allocations to each resource is coordinated across base stations.

There are several coordinated power scheduling processes that could be used in the combined power/phase coordinated scheduling scheme. The present disclosure provides a brief overview of several such coordinated power scheduling schemes.

### Fractional Frequency Reuse

A simple power coordinated scheduling scheme is fractional frequency reuse. In this scheme the transmit power levels for each time and/or frequency resource are statically assigned at each base station in a pre-determined manner. There are two general types of fractional frequency schemes:
Hard fractional frequency reuse (H-FFR), where a base station is allowed to transmit on certain frequency resources, but not on others
Soft fractional frequency reuse (S-FFR), where a base station is allowed to transmit at higher power on some resources, but at lower power on other resources.

FFR schemes are statically configured. An example of a reuse of three H-FFR scheme and a reuse of three S-FFR scheme is shown in FIG. 1. In this case the schemes are assigned across frequency resources. Such schemes can be applied, for example, to OFDM systems.

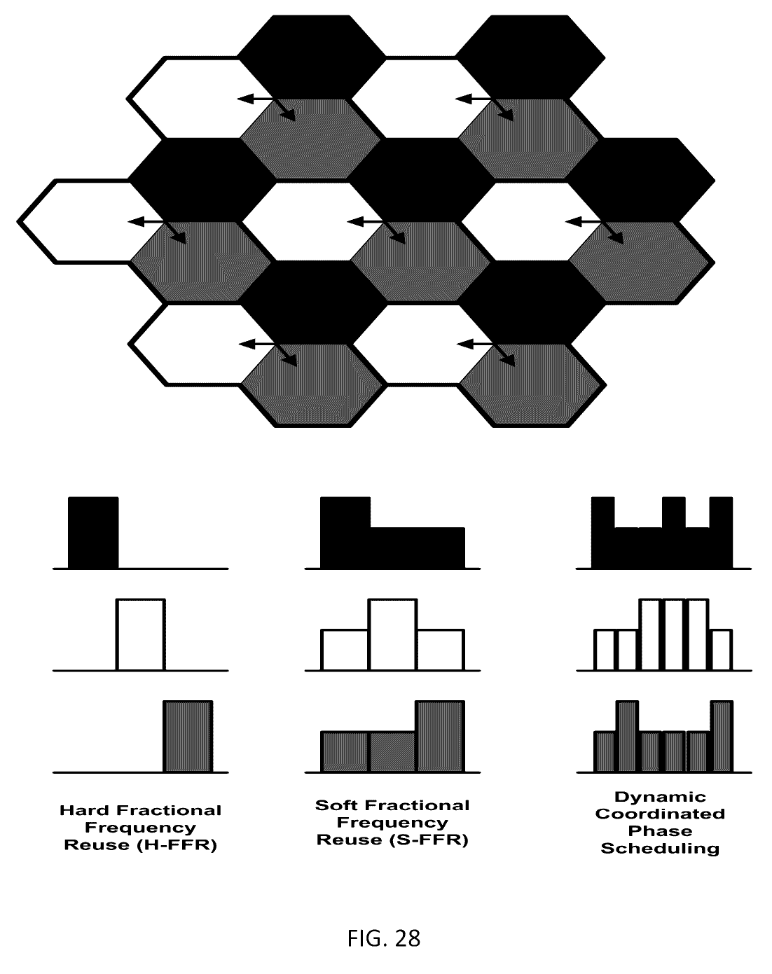

As shown in FIG. 28, there are three different resource power allocations. Base station sectors of the same color use the same transmit power allocations across frequency. In the case of H-FFR, each base station sector can only transmit on one third of the frequency resources. In the case of S-FFR, each base station can transmit on all the frequency resources. Each base station transmits at a lower power on some resources and at a higher power on other resources.

### Dynamic Coordinated Power Scheduling

In Dynamic Coordinated Power Scheduling schemes, each base station sector can have a different allocation of transmit powers across resources. Dynamic coordinated power scheduling schemes change the power allocations over time, in reaction to changes in cell loading, changes in interference levels at mobile stations, changes in network topology, etc.

There are two primary ways in which the phase coordinated and power coordinated scheduling can both be applied:
1. Apply coordinated power scheduling first, then apply coordinated phase scheduling.
2. Apply coordinated phase scheduling first, then apply coordinated power scheduling

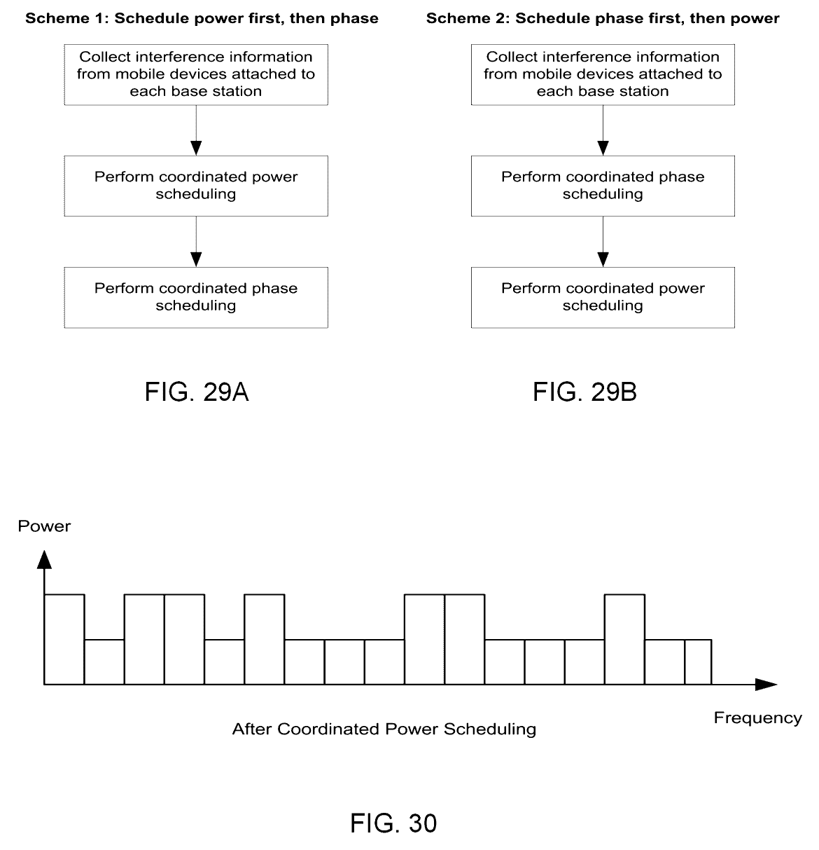

Flowcharts for both these schemes are shown in FIGS. 29a and 29b. Power first, then phase.

For the case of scheduling power first, then phase, the following steps are followed:

The steps to the combined coordinated power-phase scheduling scheme are as follows:
1. The coordinated power scheduling is applied. This can be done using coordinated power scheduling techniques such as techniques in this disclosure, or any other coordinated power scheduling technique, such a fractional frequency reuse, soft fractional frequency reuse, Inter Cell Interference Coordination (ICIC), etc.
2. The coordinated phase schedule is applied after the coordinated power scheduling has been performed.

When the coordinated phase scheduling algorithm is applied without power schedule coordination (i.e., with equal transmit power on each resource), there are generally no restrictions on which frequency resources can be assigned a fixed phase resource and which frequency resources can use variable transmission resources.

The power schedule coordination assigns a transmit power to each resource at a base station, either statically or dynamically. The phase schedule coordination assigns either a fixed transmit phase to a resource, or allows variable phases to be assigned to a resource.

In one embodiment, the combined power-phase schedule coordination scheduling method preferentially assigns fixed transmit phases to high power resources as these resources are more likely to be assigned to mobile devices that see higher interference levels and therefore utilize single layer spatial multiplexing transmissions. Fixed phase assignments can also be applied to lower power resources, depending on the preferred transmission modes for mobile devices to which these resources are assigned.

Phase scheduling can be supported in many technologies including LTE, WiMAX, WiFi. One way in which phase coordination can be supported in LTE is via Closed Loop Spatial Multiplexing (CL-SM). Here we consider phase coordination via CL-SM with two transmit antennas at the eNodeB (base station) and two receive antennas at the UE. The eNodeB can transmit either a single stream of data to a UE, also known as rank-1 transmissions, or two streams, known as rank-2 transmissions. Generally, the poorer the carrier to noise plus interference ratio (CINR) that a UE sees in the channel, the more likely it is to request rank-1 transmissions from the eNodeB. UEs with high CINR are more likely to request rank-2 transmissions.

When a fixed phase is assigned to a resource, only rank-1 transmissions with the specified phase are permitted on that resource. Resources associated with variable phase transmissions can transmit rank-1 or rank-2 CLSM data. They can also utilize any of the other LTE transmission modes such as transmit diversity and open loop spatial multiplexing.

Since higher power transmission resources are more likely to be assigned to UEs that see higher levels of interference, it is more likely that these resources will use rank-1 transmission. Therefore, fixed phases may be preferentially assigned to the higher power transmissions. Alternatively, the coordinated phase scheduler may look at rank and phase feedback from UEs to determine which resources should have a fixed phase assigned to them and which resources should be allowed to transmit at any phase.

FIG. 30 shows an example of a power schedule assigned to frequency resources at a single eNodeB.

In one embodiment of the coordinated phase scheduling scheme, the phase scheduling algorithm determines the number of fixed resources it will assign and it assigns fixed phases to the higher power resources first. If additional fixed phase resources are required then the fixed phases are assigned to the lower power resources.

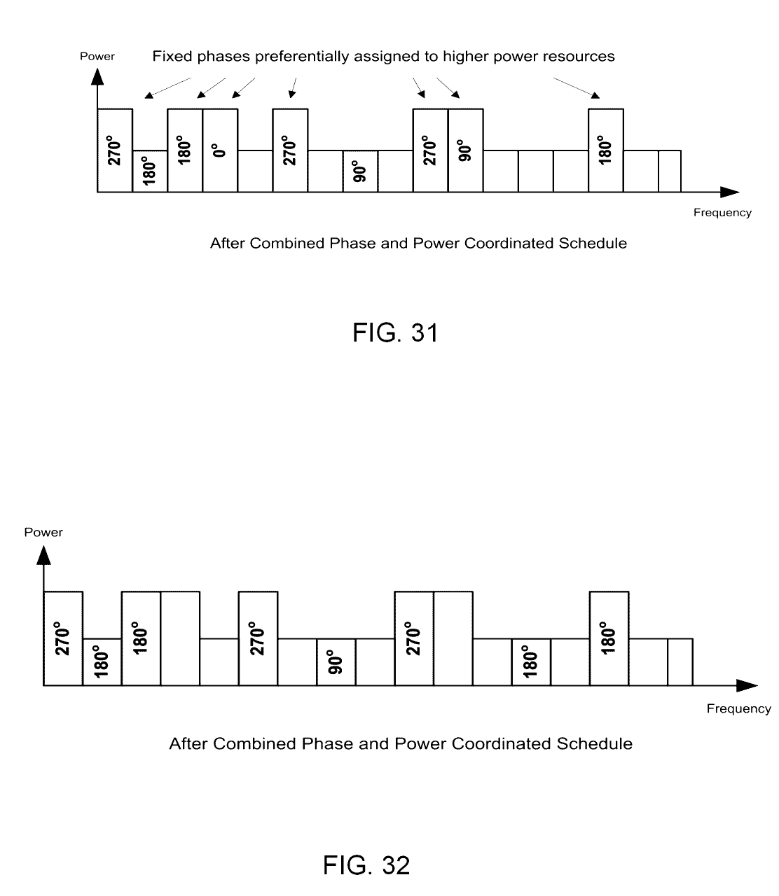

FIG. 31 shows an example of this type of phase assignment to resource blocks. Note in FIG. 31 that all the high power and some of the low powered resources have been assigned a fixed phase.

In another embodiment of the coordinated phase scheduling scheme, the phase scheduling algorithm looks at the phases and channel rank indications requested by UEs served by the eNodeB on both the high power and low power resources. The coordinated phase scheduling algorithm may assign fixed and variable phases as a function of the number of resources allocated to UEs requesting each transmission rank. For example if 60% of the resources at a particular power level are allocated to UEs that request rank-1 transmissions, then the phase scheduler may assign a fixed phase to 60% (or some function of 60%) of the resources at that power level. The actual percentage allocated by the phase scheduler may also be influenced by the amount of interference that the eNodeB is causing to neighboring sectors.

FIG. 32 shows an example of this type of phase assignment to resource blocks. In FIG. 32, several of the high power resources are permitted to use a variable phase.

In the case of coordinating the phase schedules first, then the power schedules, the following steps may be followed:

1. The coordinated phase schedule is applied.
2. The coordinated power scheduling is applied. This can be done using coordinated power scheduling techniques, or any other coordinated power scheduling technique, such a fractional frequency reuse, soft fractional frequency reuse, Inter Cell Interference Coordination (ICIC), etc.

In one embodiment of step 2 above, the phase schedule can be completely ignored while the power schedule is being applied. In an alternate embodiment of step 2, the power schedule takes into account which resources already have a fixed phase applied to them and which can use variable phases when making the coordinated power scheduling decisions. The coordinated power scheduling attempts to allocate the power resources in such a way that the number of fixed phase resources and variable phase resources at each power level are a function of the number of resources allocated to UEs requesting each transmission rank.

### Fixed/Variable Phase Transmissions for Interference Reduction

This document describes a scheme to coordinate the phase applied to data transmissions across multiple base station sectors in a network. The coordination reduces the levels of interference seen by mobile devices, resulting in a gain in system capacity and improvement in cell edge performance.

The scheme is described in the context of LTE release 8/9, but can also be applied to other OFDMA based wireless protocols.

When a base station is transmitting data to a mobile station, it can select an optimal phase adjustment to apply to its transmit signals so that the signals arrive at the mobile station with the best possible phase relationship. In addition, the interference seen by that mobile station can be reduced if the phases chosen by a neighboring base station are such that the interfering signals destructively interfere with each other as much as possible, resulting in a reduction in the interference levels.

### Phase Differences in Signals Arriving at a Receiver

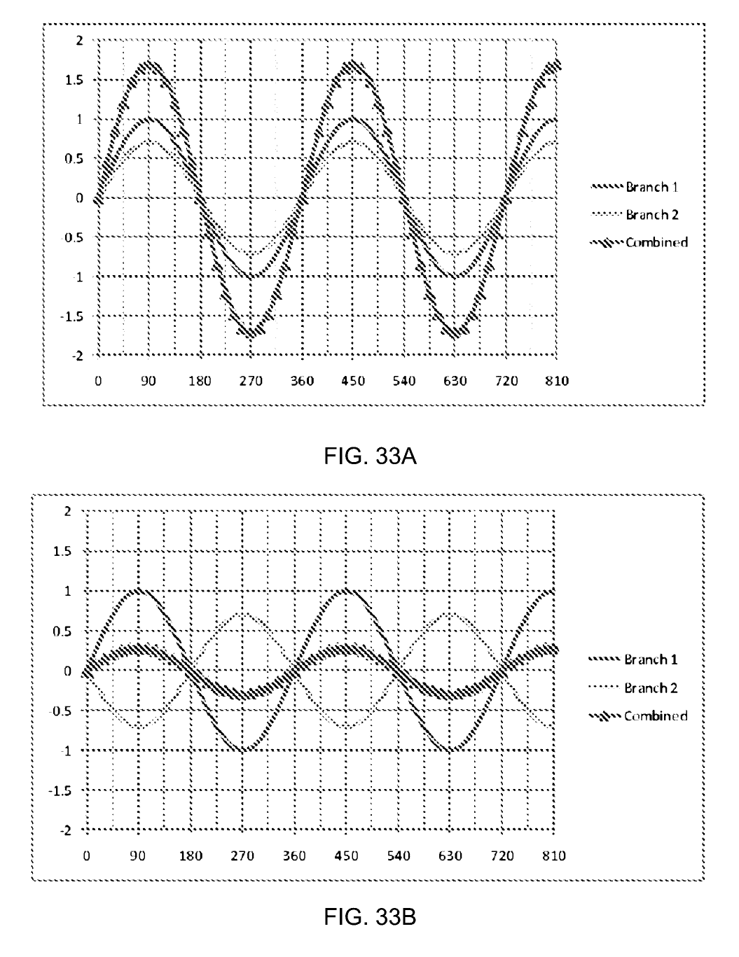

FIGS. 33A and 33B show an example of two signals with different power levels being received at a mobile station receiver. The plot on the left shows the case where the two signals are perfectly aligned with each other in phase, resulting in a much stronger received combined signal. The plot on the right shows the case where the two signals are 180° out of phase with each other. In this case, the signals do not completely cancel each other out, but the combined signal at the receiver is still attenuated significantly when compared with the case of the two separate signals being aligned perfectly with each other.

It is not necessary that the signals arriving at the receiver be aligned exactly in phase in order for a combining gain in signal strength to be achieved. Likewise, it is not necessary that the signals be exactly 180° out of phase with each other to realize a signal cancellation. Nor is it required for the amplitudes of the two signals to be equal in order to achieve a benefit.

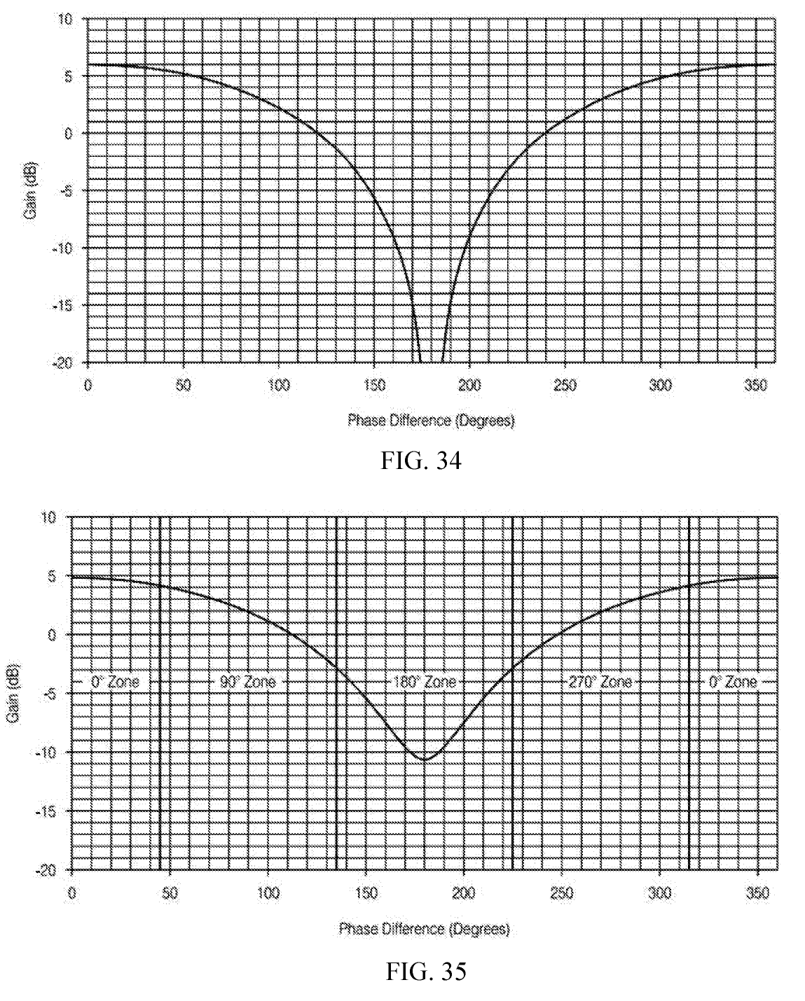

FIG. 34 shows a plot of the power gain of the combined signals, versus the phase difference of two signals at a receiver. It is assumed that both signals are received with equal amplitude.

The gain is relative to a signal sent at a nominal level of 0 dB from one of the transmit antennas. The largest gain (6 dB) is seen when the two signals are perfectly aligned in phase, while the lowest gain (in this case, perfect cancellation) is seen when the signals have a phase difference of 180°.

When the signals are transmitted from a base station to a mobile station, the channel between the base station antennas and the mobile station antennas modifies the phase differences between the signals before they arrive at a mobile station antenna. Even if identical signals are transmitted from each base station antenna with the same phase, the signals arriving at the mobile station will generally not have the same phase.

In order to improve the signal levels of the signals arriving at a mobile station from a serving base station, the mobile station can measure the phase differences of the signals arriving from each base station antenna, calculate an appropriate phase adjustment that maximizes the combined signal strength, then feed this information back to the serving base station so it can then apply an appropriate phase adjustment when it sends data to the mobile station.

In an embodiment two transmit antenna system with phase adjustments of 0 degrees, 90 degrees, 180 degrees and 270 degrees is described (e.g., 90 degree steps that can be signaled by two data bits). While finer phase adjustments are feasible, they do not necessarily result in noticeably improved performance gains.

In the same manner that the strength of a desired signal from a serving base station can be maximized via appropriate selection of transmit phase adjustments, the strength of an undesired signal from an interfering base station can be reduced if the phase adjustment of the signals from the interfering base station are chosen appropriately.

The choice of phase adjustment for signals originating from a serving base station is less critical than the choice of phase adjustments for signals originating from the interfering base stations. One of the phase adjustments from the interfering base station results in the greatest reduction in interference and subsequently the biggest improvement in CINR.

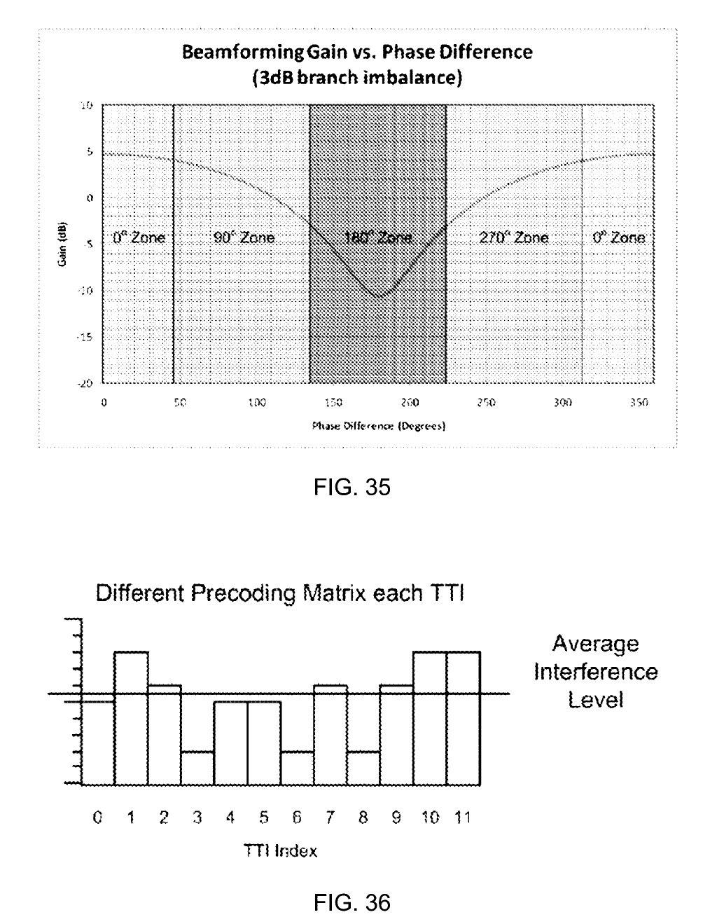

FIG. 35 shows the gain vs. phase difference when there is a 3 dB imbalance in the signal levels arriving at the receiver. In this case, the gain is relative to the stronger of the two received signals.

FIG. 35 also shows four phase adjustment zones corresponding to phase adjustments of 0 degrees, 90 degrees, 180 degrees and 270 degrees. If the two signals arrive at the receiver with a phase difference that is between 135 degrees and 225 degrees (i.e., 180 degrees+/−45 degrees) then the interference level is minimized.

In the case of a mobile station with two or more receive antennas, the calculations performed to determine the appropriate phase adjustment for either the serving base station or the interfering base station are somewhat more complicated, but the basic principle still applies. The mobile station decides on the ‘best’ phase adjustment to be applied by the serving base station and reports this data back to the base station. The ‘best’ phase adjustment may result in the best signal power as determined, for example, by a singular value decomposition of the channel matrix between the serving base station and the mobile station.

If a second base station is causing interference to the mobile station, the mobile station can also determine a ‘best’ phase adjustment to apply to the signals from the interfering base station. In this case, the ‘best’ phase adjustment may result in the least power as determined by a singular value decomposition of the channel matrix.

Note that the discussion above about achieving the best power or least interference assumes the transmission of a single stream of data (with no Spatial Multiplexing (SM)). When there are multiple transmit antennas at a base station and multiple receive antennas at a mobile station, SM may also be a viable transmission option. In SM, multiple independent streams of data are transmitted from a base station simultaneously. In this case, different information symbols are transmitted from each base station antenna. With SM, it is generally not feasible to phase align the signals from each base station antenna to achieve either a boost or reduction in signal strength.

Nevertheless, if the serving base station is using spatial multiplexing to send data to a mobile device, an interference reduction can still be achieved if the interfering base station is transmitting the same data from each antenna—e.g., if it is not using spatial multiplexing. The phases of the signals transmitted from the interfering base station can still be adjusted to achieve an interference reduction at the mobile station served by the first base station.

In LTE, the base station is referred to as the eNodeB and the mobile station is referred to as the UE.

The LTE airlink is OFDMA based with a subcarrier spacing of 15 kHz. The basic unit of transmission is a resource block (RB), which consists of 12 subcarriers, adjacent in frequency. The bandwidth of a RB is therefore 180 kHz.

The LTE airlink is divided into timeslots of 1 ms each, known as Transmit Time Intervals (TTIs). In one TTI, fourteen OFDM symbols are transmitted by an eNodeB. The basic unit of transmission form an eNodeB to a UE is therefore 12 subcarriers over 14 OFDM symbols.

The eNodeB transmits data on one or more resource blocks to a UE. The UE periodically provides information on the number of spatial streams that can be used on groups of resource blocks via the Rank Indication (RI), as well as the modulation and coding scheme to be applied to each spatial stream via the Channel Quality Index (CQI). Additionally, in closed loop MIMO (CL-MIMO), the UE informs the eNodeB of a preferred precoding matrix to be used, via the Precoding Matrix Indicator (PMI).

In the 2×2 CL-MIMO scheme, there are four precoding matrices if the rank index=1 and two precoding matrices if the rank index=2. For the purposes of interference reduction via phase coordination, the rank-one precoding matrices are the most appropriate.

An embodiment of CL-MIMO operation in LTE includes the following steps:

1. UE estimates channel matrix from serving eNodeB.
2. UE determines appropriate Rank Index, Precoding Matrix and Channel Quality Indicator and feeds this information back to the eNodeB.
3. The eNodeB can use the same precoding matrix as specified by the UE, or a different precoding matrix. Note that if a different precoding matrix is chosen by the eNodeB then a different CQI will likely have to be chosen also.
4. The eNodeB transmits data to the UE. The Downlink Channel Indicator (DCI) message sent on the downlink control channel (PDCCH) indicates to the UE what PMI and CQI were used by the eNodeB for this transmission. The UE requires this information so that it can correctly equalize and demodulate the data transmitted by the eNodeB.

The four rank-one precoding matrices defined in LTE are:

$$( \begin{matrix}1 \\ 1\end{matrix} ) , ( \begin{matrix}1 \\ j\end{matrix} ) , ( \begin{matrix}1 \\ - 1\end{matrix} ) , ( \begin{matrix}1 \\ - j\end{matrix} )$$

In an embodiment, a scaling factor of 1/sqrt(2), which may not impact the phase adjustments of the precoding matrices, may be considered.

These precoding matrices are equivalent to sending a data symbol on the first antenna and the same data symbol on the second antenna, but with a phase shift of 0, 90, 180 or 270 degrees respectively. In LTE terminology, applying a phase adjustment is equivalent to selecting a precoding matrix.

Note that the precoding matrices above are for rank-one transmission only. For rank-two transmissions (spatial multiplexing) a different set of two precoding matrices are used. As discussed previously, if a UE indicates that the eNodeB should use two transmission streams from the serving eNodeB then the performance of the rank-2 transmission can still benefit from the choice of an optimal rank-1 precoding matrix on the same RBs from the interfering eNodeB.

Some techniques require that a UE feeds back information to a serving eNodeB about the optimal phase adjustment for the serving eNodeB, as well as the optimal phase adjustments that result in the greatest levels of signal cancellation from neighboring eNodeBs. While LTE supports the PMI feedback for the serving eNodeB, it does not support any such feedback about an appropriate PMI to be used at a neighboring eNodeB.

However, if the phase adjustment applied to certain resource blocks at an interfering eNodeB can be fixed for a period of time (e.g., 100 ms or more) then reductions in interference are still possible.

Normally, an eNodeB may choose any precoding matrix when transmitting data on a given RB in a given TTI. In this case, if these transmissions are causing interference to a UE being served by a second eNodeB, the interference levels seen by the UE will change from TTI to TTI. Since the interfering eNodeB can choose a different precoding matrix for a given RB in each TTI, the phase differences between the signals arriving at the UE experiencing the interference are constantly changing. The net effect is that the instantaneous interference level in each TTI varies, depending on the precoding matrix chosen by the interfering NodeB for each TTI (see FIG. 36).

When a UE is estimating the CQI that can be used for transmission, it makes an estimate of the amount of interference plus noise that it sees in each resource block. If the UE uses an instantaneous measurement of interference plus noise from a single RB then it may select an inaccurate CQI. Generally, the UE will perform some amount of averaging of the noise over multiple RBs in order to arrive at a suitable CQI that should be used by the eNodeB when sending data to the UE. The averaging may be over the most recent N TTIs, where N is either a fixed amount of TTIs (e.g., 5 or 10), or may be an exponentially weighted average with appropriate weights.

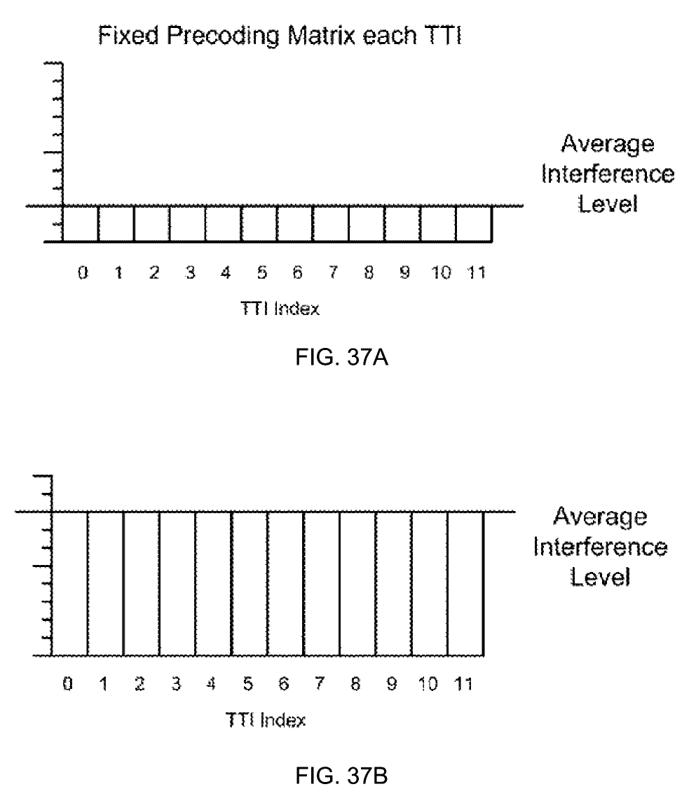

If an eNodeB is configured to always use the same rank-one precoding matrix on a given resource block then the situation changes. If a UE is stationary, or moving slowly (e.g., pedestrian speeds), then the interference levels essentially remains constant from TTI to TTI, as shown in FIGS. 37A and 37B in two separate scenarios.

If the UE is moving quickly then the motion of the UE can cause the phase differences of the received signals to vary from TTI to TTI, so the situation is essentially the same as that shown in FIG. 36, with varying interference power levels from TTI to TTI.

So, for low mobility UEs, a slowly changing interference power situation can permit additional gains in performance. If the fixed phases at the interfering eNodeB are such that the interference experienced by a UE is low in a group of resource blocks, then the standard CQI reporting mechanism will indicate to the serving eNodeB that it can use a higher CQI when transmitting data to that UE. In some cases, the interference levels may be reduced to the point that the UE can switch to spatial multiplexing on that group of resources, for even higher performance.

Note that if the precoding matrix is fixed for a particular group of resources, a given UE may or may not see a reduced level of interference. Nevertheless, over the entire population of UEs, approximately 50% will see a reduction in average interference levels on a given RB while the remaining UEs will see an increase in average interference on that RB.

If the precoding matrices are fixed across multiple RBs on an interfering eNodeB then at a UE experiencing the interference, it should expect to see a reduction in average interference plus noise in approximately 50% of the RBs and in increase in average interference plus noise in the remaining RBs.

For the baseline coordinated phase scheduling algorithm, the airlink is divided into two sections:

1. Resource blocks with a fixed precoding matrix, and
2. Resource blocks with a variable precoding matrix

The assignment of fixed and/or variable precoding matrices to a resource block varies from base station to base station sector. In a simple case, a fixed assignment is applied at each base station sector. It is important that at least some of the RBs with variable PMI are aligned in frequency with RBs with a fixed PMI on neighboring eNodeBs. An example of an assignment across three base station sectors is shown in the following Table 1:

TABLE 1
Example assignment of fixed and variable precoding matrices

| | RB Index | | | | | | | | |
|---|---|---|---|---|---|---|---|---|---|
| | 0-5 | 6-11 | 12-17 | 18-23 | 24-29 | 30-35 | 36-41 | 42-47 | 48-49 |
| eNodeB | V | F | F | V | F | F | V | V | V |
| #1 | | (0) | (90) | | (180) | (270) | | | |
| eNodeB | F | V | F | F | V | F | V | V | V |
| #2 | (270) | | (0) | (90) | | (180) | | | |
| eNodeB | F | F | V | F | F | V | V | V | V |
| #3 | (180) | (270) | | (0) | (90) | | | | |

When an eNodeB is transmitting on a resource block with a fixed precoding matrix, it must use that PMI for that resource block. By doing so, UEs attached to neighboring eNodeBs will experience a more consistent level of interference on those resources. For some UEs, the phase adjustments result in a slightly higher than average level of interference. For other UEs though, the levels of interference can be significantly reduced as a result of the phase cancellation from the neighboring eNodeB.

If a UE sees a lower interference plus noise level on a given RB, it will indicate a higher order CQI to its serving eNodeB. With the assumption that a frequency selective scheduler is being used by the eNodeB, the scheduler will preferentially select those RBs when transmitting data to the UE.

There are no restrictions on which UE can be transmitted to using a RB on which a variable precoding matrix can be used. There are also no restrictions on the rank of transmissions on these RBs—if a UE indicates rank 2 transmissions for these RBs then the serving eNodeB should schedule accordingly.

Since the precoding matrix is fixed for some RBs, ideally only transmissions to UEs that report the same precoding matrix as the fixed precoding matrix would be scheduled on these resources. If there are a sufficiently large number of UEs being serviced by an eNodeB then it could be expected that there will always be at least a few UEs that report back to the eNodeB that they prefer to use the same PMI as the fixed precoding matrix for a given group of RBs.

However, RBs with a fixed precoding matrix could also be used to transmit data to UEs that report alternative PMI indices that have phase adjustments of either +/−90 degrees away from that of the fixed precoding matrix. The precoding matrix reported by the UE will not be used—the fixed precoding matrix will be used. Since the optimum precoding matrix is not used, an embodiment may reduce the CQI level for those transmissions by one CQI step. Alternately, the reported CQI could still be used, with a slightly higher HARQ retransmission rate.

For optimal performance, it would not be expected that any data would be scheduled for any UE reporting a PMI with a phase adjustment that is 180 degrees from the fixed PM. In an embodiment, for the purposes of calculating weights for a proportional fair scheduler, the CQI reported by the UE to the eNodeB for this resource block could be dropped by three to five levels. This would discourage the proportional fair scheduler from utilizing those RBs for that UE, but leave the possibility open that the UE could still possibly end up using those RBs if they are selected by the scheduler weighting process.

There are several ways in which RBs can be configured to use either a fixed precoding matrix, or the PM indicated by the PMI feedback from the UEs.

The simplest assignment of variable/fixed precoding matrices to RBs is via a static configuration. One way to implement a static configuration is to simply define a number of allocation patterns and assign them to different eNodeBs. Three such patterns are shown in Table 1. These three patterns could be reused throughout a network of eNodeBs in a similar fashion to a reuse of three frequency assignment pattern.

In the static configuration, the selection of which precoding matrices is to be assigned to a fixed precoding matrix RB group can be done randomly, or the same precoding matrix can be assigned to each RB group, or the precoding matrix can be assigned in an incremental fashion from RB group to RB group.

The variable/fixed precoding matrix configuration can also be changed in a dynamic fashion in several ways.

An embodiment may change the fixed/variable assignment pattern and/or the number of RBs that have a fixed precoding matrix assigned to them, based on interference patterns:

a. Collect information at each eNodeB in a network about the number of UEs that are experiencing interference, the levels of interference seen at each UE and the amount of data being sent to each UE.
b. This data can then be collected at a central controller that analyzes the interference information among all eNodeBs in the network and assigns a fixed/variable precoding matrix pattern to each eNodeB. At each eNodeB, the number of RBs with fixed precoding matrix assignments can be changed based on the number of UEs for which the eNodeB is causing interference. The amount of traffic being sent to the interfered UEs can also be used to decide the number of fixed precoding matrix RBs.

An embodiment may modify the fixed precoding matrix assignments based on how well they can reduce interference. In this case the precoding matrix assigned to a fixed precoding matrix RB is determined by analyzing information from the UEs about the optimal precoding matrices from their point of view.

a. Collect information from each UE about the optimal phase adjustment to reduce the levels of interference from interfering eNodeBs.
b. Analyze the information (either at a central node or each eNodeB) to determine if there are any dominant phase adjustments that then can be assigned by interfering eNodeBs.
c. Assign the best precoding matrix to each group of fixed precoding matrix RBs.
d. Depending on how quickly the channel conditions are changing at each UE, the rate at which the above steps occur may change.

An example of an optimized set of phase assignments is shown in Table 2 below. The number of RBs with fixed precoding matrix assignments is different for each eNodeB. Also, the alignment of the RBs with fixed and variable precoding matrices is varied across the eNodeBs.

TABLE 2
Example optimized phase assignment table

| | RB Index | | | | | | | | |
|---|---|---|---|---|---|---|---|---|---|
| | 0-5 | 6-11 | 12-17 | 18-23 | 24-29 | 30-35 | 36-41 | 42-47 | 48-49 |
| eNodeB | V | F | V | V | F | V | V | F | V |
| #1 | | (90) | | | (180) | | | (0) | |
| eNodeB | F | V | F | F | F | V | V | V | V |
| #2 | (0) | | (0) | (90) | (90) | | | | |
| eNodeB | F | V | V | F | V | V | V | F | V |
| #3 | (180) | | | (180) | | | | (270) | |

The phase coordination algorithms disclosed in this paper can also be used in conjunction with other interference reduction techniques. For example, fixed precoding mapping can be overlaid on the resource block power allocations in a fractional frequency reuse scheme. In FFR, different powers are allocated to different resource blocks. The power allocation pattern is varied from eNodeB to eNodeB. The power allocation pattern can be preprovisioned or can change dynamically, such as in the LTE Inter Cell Interference Coordination (ICIC), as a non-limiting example.

Since cell edge users will generally be allocated higher transmit power resources in a FFR scheme, the RBs that are assigned a fixed precoding matrix will generally be those that are allocated a higher transmit power in the FFR scheme.

What is claimed is:

1. A method for determining relationships in a wireless network, the method comprising:
collecting information for a plurality of nodes;
analyzing the information for the plurality of nodes; and
changing a network parameter based on a result of the analysis.
